(19) United States
(12) Patent Application Publication
(10) Pub. No.: US 2026/0121292 A1
(43) Pub. Date: Apr. 30, 2026

(54) ANTENNA APPARATUS AND COMMUNICATION DEVICE

(71) Applicant: Huawei Technologies Co., Ltd., Shenzhen (CN)

(72) Inventors: Tuanjie Xue, Shanghai (CN); Guanxi Zhang, Shanghai (CN); Bojie Li, Shanghai (CN)

(21) Appl. No.: 19/003,683

(22) Filed: Dec. 27, 2024

Related U.S. Application Data
(63) Continuation of application No. PCT/CN2023/101701, filed on Jun. 21, 2023.

(30) Foreign Application Priority Data
Jun. 29, 2022 (CN) 202210757634.6

(51) Int. Cl. H01Q 3/30; H01Q 1/24; H01Q 21/00; H01Q 21/08

(52) U.S. Cl. CPC H01Q 3/30; H01Q 1/246; H01Q 21/0075; H01Q 21/08

(57) ABSTRACT

An antenna apparatus and a communication device are provided, and relate to the field of communication technologies. Two input ports of a first bridge and two input ports of a second bridge in the antenna apparatus are respectively connected to four radio frequency ports. Two input ports of a third bridge in the antenna apparatus are respectively connected to a second output port of the first bridge and a fourth output port of the second bridge, and a fifth output port of the third bridge is connected to N3 radiating element arrays disposed on a second installation surface. Power of signals sent by the four radio frequency ports may be concentrated on a radiating element array on the first installation surface or the second installation surface.

### CROSS-REFERENCE TO RELATED APPLICATIONS

This application is a continuation of International Application No. PCT/CN2023/101701, filed on Jun. 21, 2023, which claims priority to Chinese Patent Application No. 202210757634.6, filed on Jun. 29, 2022. The disclosures of the aforementioned applications are hereby incorporated by reference in their entireties.

### TECHNICAL FIELD

This application relates to the field of communication technologies, and specifically, to an antenna apparatus and a communication device.

### BACKGROUND

In a wireless communication network, an access network device (for example, a base station), as a key network node, plays a key role in the communication network. With development of mobile communication, access network device forms are also diversified. The access network device includes an antenna, and the access network device receives and sends signals by using the antenna. The antenna includes a radiating element array and an antenna port. The radiating element array may be connected to the antenna port, and the antenna port may be connected to a radio frequency port.

The antenna port and the radio frequency port may be connected in one-to-one correspondence. To implement power sharing between radiating element arrays connected to a plurality of antenna ports, the antenna ports may alternatively be connected to radio frequency ports in a many-to-many manner. For example, each of the plurality of radio frequency ports may be connected to each of the plurality of antenna ports. When a part of the plurality of antenna ports are in a working state, power of signals sent by the plurality of radio frequency ports is still distributed on each of the plurality of antenna ports (including an antenna port in a working state and an antenna port not in a working state), resulting in a power waste.

### SUMMARY

This application provides an antenna apparatus and a communication device, to reduce a power waste.

According to a first aspect, this application provides an antenna apparatus. The antenna apparatus includes a first installation surface, a second installation surface, a plurality of radiating element arrays, and a first circuit unit. The first circuit unit includes a first bridge, a second bridge, and a third bridge.

A first input port of the first bridge is connected to a first radio frequency port, and a second input port of the first bridge is connected to a second radio frequency port. A first output port of the first bridge is connected to antenna ports connected to N1 radiating element arrays that are in the plurality of radiating element arrays and that are disposed on the first installation surface. N1 is a positive integer.

A third input port of the second bridge is connected to a third radio frequency port, and a fourth input port of the second bridge is connected to a fourth radio frequency port. A third output port of the second bridge is connected to antenna ports connected to N2 radiating element arrays that are in the plurality of radiating element arrays and that are disposed on the first installation surface, N2 is a positive integer, and each of the N2 radiating element arrays is different from each of the N1 radiating element arrays.

A second output port of the first bridge is connected to a fifth input port of the third bridge. A fourth output port of the second bridge is connected to a sixth input port of the third bridge. A fifth output port of the third bridge is connected to antenna ports connected to N3 radiating element arrays disposed on the second installation surface. N3 is a positive integer. An included angle between the first installation surface and the second installation surface on a side that is away from the N1 radiating element arrays is a first included angle, and the first included angle is less than 180°.

Because the first radio frequency port, the second radio frequency port, the third radio frequency port, and the fourth radio frequency port may be connected to the N1 radiating element arrays, the N2 radiating element arrays, and the N3 radiating element arrays by using the first bridge unit, power sharing may be implemented between the plurality of radiating element arrays, and power of each array may be adjusted based on a requirement.

In this application, the first output port of the first bridge is connected to the antenna ports connected to the N1 radiating element arrays that are in the plurality of radiating element arrays and that are disposed on the first installation surface. Therefore, power of signals input by the first input port and the second input port may be concentrated on a signal output by one output port of the first bridge.

In addition, because the third output port of the second bridge is connected to the antenna ports connected to the N2 radiating element arrays that are in the plurality of radiating element arrays and that are disposed on the first installation surface, power of signals input by the third input port and the fourth input port of the second bridge may be concentrated on a signal output by one output port of the second bridge.

In addition, the second output port of the first bridge is connected to the fifth input port of the third bridge. The fourth output port of the second bridge is connected to the sixth input port of the third bridge. Power of signals input by the fifth input port and the sixth input port of the third bridge may be concentrated on a signal output by one output port of the third bridge, for example, may be concentrated on the N3 radiating element arrays connected to the fifth output port.

Therefore, when the radiating element arrays (the N1 radiating element arrays and the N2 radiating element arrays) deployed on the first installation surface of the antenna apparatus are in a working state, while the radiating element arrays (the N3 radiating elements) deployed on the second installation surface are not in a working state, power of signals sent by the first radio frequency port and the second radio frequency port may be concentrated on the N1 radiating element arrays deployed on the first installation surface, and power of signals sent by the third radio frequency port and the fourth radio frequency port may be concentrated on the N2 radiating element arrays deployed on the first installation surface, so that power utilization can be improved, and a power waste can be reduced.

Similarly, when the radiating element arrays deployed on the second installation surface of the antenna apparatus are in a working state, while the radiating element arrays deployed on the first installation surface are not in a working state, power of signals sent by the first radio frequency port, the second radio frequency port, the third radio frequency port, and the fourth radio frequency port may be concentrated on the N3 radiating element arrays deployed on the second installation surface, so that power utilization can be improved, and a power waste can be reduced.

In addition, each of the N2 radiating element arrays is different from each of the N1 radiating element arrays. When the radiating element arrays deployed on the second installation surface of the antenna apparatus are in a working state, while the radiating element arrays deployed on the first installation surface are not in a working state, a logical port formed by the first radio frequency port and the second radio frequency port and a logical port formed by the third radio frequency port and the fourth radio frequency port may not interfere with each other in an analog circuit. To be specific, power and phases of signals sent by the first radio frequency port and the second radio frequency port are set based on a requirement of the N1 radiating element arrays. Power and phases of signals sent by the third radio frequency port and the fourth radio frequency port are set based on a requirement of the N2 radiating element arrays. Therefore, a power amplifier connected to each radio frequency port can send a signal at power supported by the power amplifier, so that a problem that a power amplifier connected to a radio frequency port cannot send a signal at power supported by the power amplifier can be avoided, thereby reducing a power waste caused by power overrun.

In a possible implementation, the third bridge may further include a sixth output port, and the sixth output port may be connected to a load. In another possible implementation, the antenna apparatus further includes a third installation surface. The sixth output port of the third bridge is connected to antenna ports connected to N4 radiating element arrays disposed on the third installation surface. N4 is a positive integer.

When the radiating element arrays (the N4 radiating element arrays) deployed on the third installation surface of the antenna apparatus are in a working state, while the radiating element arrays deployed on the first installation surface and the second installation surface are not in a working state, power of signals sent by the first radio frequency port, the second radio frequency port, the third radio frequency port, and the fourth radio frequency port may be concentrated on the N4 radiating element arrays deployed on the third installation surface, so that power utilization can be improved, and a power waste can be reduced.

In a possible implementation, the third installation surface may be an installation surface different from the first installation surface and the second installation surface. For example, the third installation surface and the second installation surface are located on two opposite sides of the first installation surface. In this way, if a radiated signal of a radiating element array disposed on each installation surface covers one cell (for example, one cell is a 120° sector region), the antenna apparatus can cover a 360° region. This solution helps reduce costs of a communication system.

In this application, the third bridge may be directly connected to the N3 radiating element arrays, or the third bridge may be connected to the N3 radiating element arrays by using another component. For example, in a possible implementation, the antenna apparatus further includes a fourth bridge, and the third bridge may be connected to the N3 radiating element arrays by using the fourth bridge. For example, the fifth output port of the third bridge is connected to a seventh input port of the fourth bridge, and a seventh output port of the fourth bridge is connected to the N3 radiating element arrays. It can be learned that the third bridge may be connected to the N3 radiating element arrays by using the fourth bridge, so that the N3 radiating element arrays may be connected to more radio frequency ports by using the fourth bridge.

For example, the antenna apparatus further includes a second circuit unit, and an eighth input port of the fourth bridge is connected to a ninth output port of the second circuit unit. In this way, the N3 radiating element arrays may be connected, by using the fourth bridge, to radio frequency ports connected to the two circuit units, so that when the N3 radiating element arrays are in a working state, power of signals sent by the radio frequency ports connected to the two circuit units may be concentrated on a signal sent by the N3 radiating element arrays.

In a possible implementation, an eighth output port of the fourth bridge is connected to the antenna ports connected to the N4 radiating element arrays disposed on the third installation surface. N4 is a positive integer. In this way, the N4 radiating element arrays may be connected, by using the fourth bridge, to the radio frequency ports connected to the two circuit units, so that when the N4 radiating element arrays are in a working state, power of signals sent by the radio frequency ports connected to the two circuit units may be concentrated on a signal sent by the N4 radiating element arrays.

In a possible implementation, the antenna apparatus further includes a first power divider, and the first bridge is connected to the N1 radiating element arrays by using the first power divider. For example, when N1 is greater than 1, the first output port of the first bridge is connected to an input port of the first power divider, and output ports of the first power divider are connected to the N1 radiating element arrays. It can be learned that, in this application, with a function of the first power divider, power of a signal sent by the first output port may be allocated to the N1 radiating element arrays connected to the first power divider. With the first power divider, more radiating element arrays can be supported without increasing a quantity of radio frequency ports. Because the quantity of radio frequency ports is small, this solution can reduce costs. In addition, because a quantity of radiating element arrays can be increased, performance of the antenna apparatus can be improved.

In a possible implementation, the antenna apparatus further includes a first phase shifter, and the first bridge is connected to a radiating element array in the N1 radiating element arrays by using the first phase shifter. A phase of a signal output by the first bridge may be changed by using the first phase shifter, so that adjustability of the antenna apparatus in an actual application scenario can be improved.

In a possible implementation, one output port of the first power divider is connected to one of the N1 radiating element arrays by using the first phase shifter. Because a phase of a signal to be sent by the radiating element array may be adjusted by using the first phase shifter, a beamforming capability (which may also be referred to as a beam scanning capability) of the N1 radiating element arrays may be improved.

In a possible implementation, the antenna apparatus further includes a first microstrip, and the first bridge is connected to the N1 radiating element arrays by using the first microstrip. The first microstrip may be configured to adjust a phase of a received signal, so that adjustability of the antenna apparatus in an actual application scenario can be improved.

In a possible implementation, the first output port of the first bridge is connected to the N1 radiating element arrays by using the first microstrip. In this way, a phase of a signal output by the first output port of the first bridge may be adjusted by using the first microstrip, so that a phase of a signal received by a radiating element array connected to the first microstrip is aligned with a phase of a signal received by a radiating element array connected to the second output port of the first bridge, and then the radiating element arrays may output phase-aligned signals, thereby improving signal strength.

In a possible implementation, the first microstrip is configured to delay, by a first preset value, a phase of a signal output by the first output port of the first bridge. For example, the first preset value may be determined based on a phase difference between the phase of the signal output by the first output port of the first bridge and a phase of a signal received by the N3 radiating element arrays.

For example, when the second output port of the first bridge is connected to a radiating element array by using the third bridge, because a phase of a signal output by the third bridge is 90 degrees deflected from a phase of a signal output by the first bridge, the first microstrip may be configured to delay, by 90 degrees, the phase of the signal output by the first output port of the first bridge (that is, the first preset value is 90 degrees). For another example, if the phase of the signal received by the N3 radiating element arrays connected to the third bridge is 180 degrees deflected from the phase of the signal output by the first bridge, the first preset value may be 180 degrees.

In this way, the phase, adjusted by the first microstrip, of the signal may be aligned with a phase of a signal output by an output port of the third bridge. Further, a phase of a signal received by a radiating element array connected to the first microstrip may be aligned with a phase of a signal received by a radiating element array connected to the second output port of the first bridge, and then the radiating element arrays may output phase-aligned signals, thereby improving signal strength.

In this application, a parameter of the first bridge may be flexibly set based on an actual requirement. To be better compatible with a conventional technology, the first bridge may be a 90-degree bridge or a 180-degree bridge.

In a possible implementation, the first bridge includes two input ports and two output ports. A power ratio of the first bridge may be flexibly set, for example, may be set to 2:1 or 1:1. That the power ratio of the first bridge is 1:1 may be understood as that for a signal input by one input port (for example, the first input port or the second input port) of the first bridge, a power ratio of signals output by the first output port and the second output port is 1:1.

In this way, when two signals received by the two input ports of the first bridge have a phase difference of 90 degrees and have equal amplitudes (a power ratio is 1:1), power of the signals received by the two input ports may be concentrated on a signal output by one output port of the first bridge. Output power that can be supported by a plurality of power amplifiers connected to the two input ports of the first bridge may be equal. Therefore, when the power ratio of the first bridge is 1:1, the plurality of power amplifiers can all transmit signals at the output power supported by the plurality of power amplifiers. In this way, a power ratio of two input signals of the first bridge can be 1:1, thereby reducing a power waste. In addition, when the plurality of power amplifiers transmit signals at the output power that can be supported by the plurality of power amplifiers, power underrun can be alleviated.

In a possible implementation, the antenna apparatus further includes a second power divider, and the second bridge is connected to the N2 radiating element arrays by using the second power divider. For example, when N2 is greater than 1, the third output port of the second bridge is connected to an input port of the second power divider, and output ports of the second power divider are connected to the N2 radiating element arrays.

It can be learned that, in this application, with a function of the second power divider, power of a signal sent by the third output port may be allocated to the N2 radiating element arrays connected to the second power divider. With the second power divider, more radiating element arrays can be supported without increasing a quantity of radio frequency ports. Because the quantity of radio frequency ports is small, this solution can reduce costs. In addition, because a quantity of radiating element arrays can be increased, performance of the antenna apparatus can be improved.

In a possible implementation, the antenna apparatus further includes a second phase shifter, and the second bridge is connected to a radiating element array in the N2 radiating element arrays by using the second phase shifter. A phase of a signal output by the second bridge may be changed by using the second phase shifter, so that adjustability of the antenna apparatus in an actual application scenario can be improved.

In a possible implementation, one output port of the second power divider is connected to one of the N2 radiating element arrays by using the second phase shifter. Because a phase of a signal to be sent by the radiating element array may be adjusted by using the second phase shifter, a beamforming capability (which may also be referred to as a beam scanning capability) of the N2 radiating element arrays may be improved.

In a possible implementation, the antenna apparatus further includes a second microstrip, and the second bridge is connected to the N2 radiating element arrays by using the second microstrip. The second microstrip may be configured to adjust a phase of a received signal, so that adjustability of the antenna apparatus in an actual application scenario can be improved.

In a possible implementation, the third output port of the second bridge is connected to the N2 radiating element arrays by using the second microstrip.

In this way, a phase of a signal output by the third output port of the second bridge may be adjusted by using the second microstrip, so that a phase of a signal received by a radiating element array connected to the second microstrip is aligned with a phase of a signal received by a radiating element array connected to the fourth output port of the second bridge, and then the radiating element arrays may output phase-aligned signals, thereby improving signal strength.

In a possible implementation, the second microstrip is configured to delay, by a second preset angle, a phase of a signal output by the third output port of the second bridge. For example, the second preset angle may be determined based on a phase difference between the phase of the signal output by the third output port of the second bridge and the phase of the signal received by the N3 radiating element arrays.

For example, when the fourth output port of the second bridge is connected to a radiating element array by using the third bridge, because a phase of a signal output by the third bridge is 90 degrees deflected from a phase of a signal output by the second bridge, the second microstrip may be configured to delay, by 90 degrees, the phase of the signal output by the third output port of the second bridge (that is, the second preset angle is 90 degrees). For another example, if the phase of the signal received by the N3 radiating element arrays connected to the third bridge is 180 degrees deflected from the phase of the signal output by the second bridge, the second preset angle may be 180 degrees.

In this way, the phase, adjusted by the second microstrip, of the signal may be aligned with a phase of a signal output by an output port of the third bridge, a phase of a signal received by a radiating element array connected to the second microstrip may be aligned with a phase of a signal received by a radiating element array connected to the fourth output port of the second bridge, and then the radiating element arrays may output the phase-aligned signals, thereby improving signal strength.

In this application, a parameter of the first bridge may be flexibly set based on an actual requirement. To be better compatible with a conventional technology, the second bridge is a 90-degree bridge or a 180-degree bridge.

In a possible implementation, the second bridge includes two input ports and two output ports. A power ratio of the second bridge may be flexibly set, for example, may be set to 2:1 or 1:1. That the power ratio of the second bridge is 1:1 may be understood as that for a signal input by one input port (for example, the third input port or the fourth input port) of the second bridge, a power ratio of signals output by the third output port and the fourth output port is 1:1.

In this way, when two signals received by the two input ports of the second bridge have a phase difference of 90 degrees and have equal amplitudes (a power ratio is 1:1), power of the signals received by the two input ports may be concentrated on a signal output by one output port of the first bridge (for example, in a possible example, the power of the signals received by the two input ports may be all concentrated on a signal output by one output port of the first bridge). Output power that can be supported by a plurality of power amplifiers connected to the two input ports of the second bridge may be equal. Therefore, when the power ratio of the second bridge is 1:1, the plurality of power amplifiers can all transmit signals at the output power supported by the plurality of power amplifiers. In this way, a power ratio of two input signals of the second bridge can be 1:1, thereby reducing a power waste. In addition, when the plurality of power amplifiers transmit signals at the output power that can be supported by the plurality of power amplifiers, power underrun can be alleviated.

In a possible implementation, a parameter of the third bridge may be flexibly set based on an actual requirement. To be better compatible with a conventional technology, the third bridge is a 90-degree bridge or a 180-degree bridge. In a possible implementation, the third bridge includes two input ports and two output ports. A power ratio of the third bridge is 1:1. For related descriptions and beneficial effects, refer to related descriptions of the first bridge or the second bridge. Details are not described again.

In a possible implementation, the plurality of radiating elements further include N5 radiating element arrays disposed on the first installation surface, N5 is a positive integer, and the N5 radiating element arrays are connected to a fifth radio frequency port. In this embodiment of this application, N5 may be 1, or may be an integer greater than 1. When there are a large quantity of radiating element arrays on the first installation surface, radio frequency ports may be disposed in one-to-one and/or one-to-many correspondence with antenna ports. In this way, a quantity of radio frequency links can be reduced.

In a possible implementation, when N5 is an integer greater than 1, the fifth radio frequency port is connected to the N5 radiating element arrays by using a third power divider.

It can be learned that, in this application, with a function of the third power divider, power of a signal sent by the fifth radio frequency port may be allocated to at least two radiating element arrays. With the third power divider, more radiating element arrays can be supported without increasing a quantity of radio frequency ports. Because the quantity of radio frequency ports is small, this solution can reduce costs. In addition, because a quantity of radiating element arrays can be increased, performance of the antenna apparatus can be improved.

In a possible implementation, the third power divider is connected to the N5 radiating element arrays by using a third phase shifter. Because a phase of a signal to be sent by the radiating element array may be adjusted by using the third phase shifter, a beamforming capability (which may also be referred to as a beam scanning capability) of the N5 radiating element arrays may be improved.

According to a second aspect, this application provides a communication device, including the antenna apparatus according to any one of the first aspect or the possible implementations of the first aspect in the foregoing content.

According to a third aspect, this application provides a communication system, including the antenna apparatus according to any one of the first aspect or the possible implementations of the first aspect in the foregoing content.

### BRIEF DESCRIPTION OF THE DRAWINGS

FIG. 1A is a diagram of an architecture of a communication system to which embodiments of this application are applicable;

FIG. 1B is a diagram of a structure of an antenna apparatus according to an embodiment of this application;

FIG. 2A is a diagram of a possible structure of an access network device according to an embodiment of this application;

FIG. 2B is a diagram of a possible structure of a part of components in an antenna apparatus 1 according to an embodiment of this application;

FIG. 2C is a diagram of another possible structure of an access network device according to an embodiment of this application;

FIG. 2D is a diagram of a possible structure of a part of components in an antenna apparatus 1 according to an embodiment of this application;

FIG. 2E is a diagram of another possible structure of an access network device according to an embodiment of this application;

FIG. 3A is a diagram of a possible structure of an antenna apparatus 1 according to an embodiment of this application;

FIG. 3B is a diagram of another possible structure of an antenna apparatus 1 according to an embodiment of this application;

FIG. 3C is a diagram of another possible structure of an antenna apparatus 1 according to an embodiment of this application;

FIG. 4A is a diagram of another possible structure of an antenna apparatus 1 according to an embodiment of this application;

FIG. 4B is a diagram of another possible structure of an antenna apparatus 1 according to an embodiment of this application;

FIG. 5A is a diagram of another possible structure of an antenna apparatus 1 according to an embodiment of this application;

FIG. 5B is a diagram of another possible structure of an antenna apparatus 1 according to an embodiment of this application; and

FIG. 6 is a diagram of a networking structure of a communication system according to an embodiment of this application.

### DETAILED DESCRIPTION OF ILLUSTRATIVE EMBODIMENTS

The following explains terms that occur or may occur in this application:
1. At least one means one or more, that is, including one, two, three, or more.
2. A plurality of means two or more, that is, including two, three, four, or more.
3. Connected means coupled, including being directly connected or indirectly connected via another component to implement electrical connectivity.

A communication system to which embodiments of this application are applicable may be a 5th generation (5G) network architecture, or may be another network architecture, for example, a global system for mobile communication (GSM), a code division multiple access (CDMA) system, a wideband code division multiple access (WCDMA) system, a general packet radio service (GPRS), a long term evolution (LTE) system, an advanced long term evolution (LTE-A) system, a universal mobile telecommunication system (UMTS), an evolved long term evolution (eLTE) system, or other mobile communication systems such as 6G in the future.

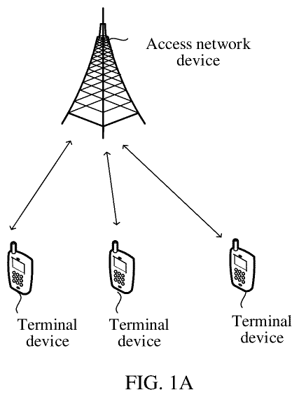

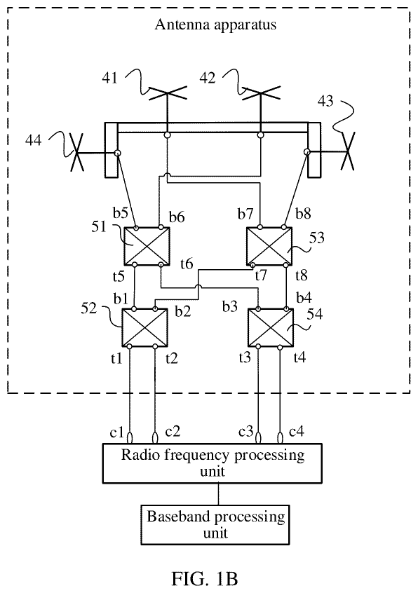

FIG. 1A is an example diagram of an architecture of the communication system to which embodiments of this application are applicable.

As shown in FIG. 1A, the communication system includes an access network device and a terminal device. Embodiments of this application provide an antenna apparatus. The antenna apparatus is an antenna apparatus of the access network device. The access network device may communicate a signal with the terminal device by using the antenna apparatus. The antenna apparatus provided in embodiments of this application may also be referred to as an antenna feeder system. FIG. 1A shows an example in which the access network device is a base station.

The following describes devices in embodiments of this application with reference to FIG. 1A.

### (1) Access Network Device.

The access network device may be a (radio) access network ((R)AN) device, and is configured to provide a network access function for an authorized terminal device in a specific region, and can use transmission tunnels of different quality based on a level of the terminal device, a requirement of a service, and the like.

The access network device is a device that provides a wireless communication function for the terminal device. The access network device in this application includes but is not limited to a next generation NodeB (gNodeB or gNB) in 5G, an evolved NodeB (eNB), a radio network controller (RNC), a NodeB (NB), a base station controller (BSC), a base transceiver station (BTS), a home base station (for example, a home evolved NodeB or a home NodeB, HNB), a baseband unit (BBU), a transmission reception point (TRP), a transmission point (TP), a mobile switching center, and the like.

### (2) Terminal Device.

The terminal device may be a device configured to implement a wireless communication function. FIG. 1A shows an example in which the terminal device is a mobile phone. In a specific implementation, the terminal device may be user equipment (UE), an access terminal, a terminal unit, a terminal station, a mobile station, a mobile, a remote station, a remote terminal, a mobile device, a wireless communication device, a terminal agent, a terminal apparatus, or the like in a 5G network or a future evolved public land mobile network (PLMN). The access terminal may be a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, an in-vehicle device, a wearable device, a virtual reality (VR) terminal device, an augmented reality (AR) terminal device, a wireless terminal in industrial control, a wireless terminal in self-driving, a wireless terminal in remote medical, a wireless terminal in a smart grid, a wireless terminal in transportation safety, a wireless terminal in a smart city, a wireless terminal in a smart home, or the like. The terminal may be mobile or fixed.

To further describe advantages of solutions provided in embodiments of this application, FIG. 1B shows an example diagram of an architecture of an access network device according to an embodiment of this application.

As shown in FIG. 1B, the architecture of the access network device may include an antenna apparatus. The architecture of the access network device may further include another component. FIG. 1B shows an example in which the architecture of the access network device further includes a radio frequency processing unit and a baseband processing unit. FIG. 1B shows an example in which the antenna apparatus is connected to the radio frequency processing unit and the radio frequency processing unit is connected to the baseband processing unit. In actual application, there may be another connection relationship between the antenna apparatus and another component in the architecture of the access network device.

The radio frequency processing unit includes a radio frequency port, for example, a radio frequency port c1, a radio frequency port c2, a radio frequency port c3, and a radio frequency port c4 shown in FIG. 1B. The antenna apparatus includes a radiating element array, for example, a radiating element array 41, a radiating element array 42, a radiating element array 43, and a radiating element array 44 shown in FIG. 1B. The antenna apparatus further includes a bridge, for example, a bridge 51, a bridge 52, a bridge 53, and a bridge 54 shown in FIG. 1B.

As shown in FIG. 1B, an input port t1 and an input port t2 of the bridge 52 are respectively connected to the radio frequency port c1 and the radio frequency port c2, and an output port b1 and an output port b2 of the bridge 52 are respectively connected to an input port t5 of the bridge 51 and an input port t7 of the bridge 53. An input port t3 and an input port t4 of the bridge 54 are respectively connected to the radio frequency port c3 and the radio frequency port c4, and an output port b3 and an output port b4 of the bridge 54 are respectively connected to an input port t6 of the bridge 51 and an input port t8 of the bridge 53. An output port b5 and an output port b6 of the bridge 51 are respectively connected to the radiating element array 44 and the radiating element array 42. An output port b7 and an output port b8 of the bridge 53 are respectively connected to the radiating element array 41 and the radiating element array 43.

To meet different requirements of different terminal devices, amplitudes or phases of signals sent by two radiating element arrays are probably different. The radiating element array 41 and the radiating element array 42 are used as an example. When signals generated by the baseband meet amplitudes or phases of signals sent by the radiating element array 41 and the radiating element array 42, it is equivalent that a plurality of intra-frequency signals are superimposed at the same time in the baseband, resulting in that an amplitude and a phase of a combined baseband signals are random, and when the signal passes through power amplifiers (a power amplifier connected to the radio frequency port c1, a power amplifier connected to the radio frequency port c2, a power amplifier connected to the radio frequency port c3, and a power amplifier connected to the radio frequency port c4), because the power amplifiers have different output power, at least one power amplifier does not send the signal at output power supported by the power amplifier, that is, at least one power amplifier has a power overrun (or power underrun) problem.

In addition, when a part of the radiating element arrays connected to the radio frequency port c1, the radio frequency port c2, the radio frequency port c3, and the radio frequency port c4 are in a working state, a part of power of signals sent by the four radio frequency ports may be allocated to the radiating element arrays in a working state, resulting in a power waste. The following uses an example in which the radiating element array 41 and the radiating element array 42 are in a working state, while the radiating element array 123 and the radiating element array 122 are not in a working state for description.

For example, each power amplifier (the power amplifier connected to the radio frequency port c1, the power amplifier connected to the radio frequency port c2, the power amplifier connected to the radio frequency port c3, and the power amplifier connected to the radio frequency port c4) in the radio frequency processing unit 2 sends a signal at output power supported by the power amplifier. For example, in this embodiment of this application, each power amplifier in the radio frequency processing unit 2 may send a signal by using rated output power or maximum output power supported by the power amplifier. In this embodiment of this application, the maximum output power may also be referred to as instantaneous power or peak power, and may be greater than the rated power. In this embodiment of this application, the power amplifiers connected to the radio frequency processing unit 2 may have same rated output power or maximum output power. In this case, if two signals received by the radio frequency port c1 and the radio frequency port c2 have a phase difference of 90 degrees (for example, the bridge 52 is a 90-degree bridge), the bridge 52 may send, through one port (the output port b1 or the output port b2), signals received by the input port t1 and the input port t2. For example, the signals are sent through the output port b2. In this case, because the output port b1 sends no signal, the input port t5 of the bridge 51 receives no signal, and the input port t7 of the bridge 53 receives a signal from the output port b2. Similarly, the bridge 54 may also have one output port sending a signal. For example, the output port b3 of the bridge 51 may send a signal, and the output port b4 sends no signal.

Because the input port t5 of the bridge 51 receives no signal, and the input port t6 receives a signal from the output port b3, the bridge 51 allocates all power of the signal received by the input port to the output ports b5 and b6, and cannot allocate all the power of the received signal to a signal sent by the radiating element array connected to the output port b6. Similarly, the bridge 53 allocates all power of the signal received by the input port to the output ports b7 and b8, and cannot allocate all the power of the received signal to a signal sent by the radiating element array connected to the output port b7.

In the system architecture shown in FIG. 1B, when a part of the radiating element arrays connected to the radio frequency port c1, the radio frequency port c2, the radio frequency port c3, and the radio frequency port c4 are in a working state, for example, the radiating element array 41 and the radiating element array 42 are in a working state, while the radiating element array 123 and the radiating element array 122 are not in a working state, a part of power of signals sent by the radio frequency port c1, the radio frequency port c2, the radio frequency port c3, and the radio frequency port c4 may be allocated to the radiating element array 41 and the radiating element array 42, resulting in a power waste.

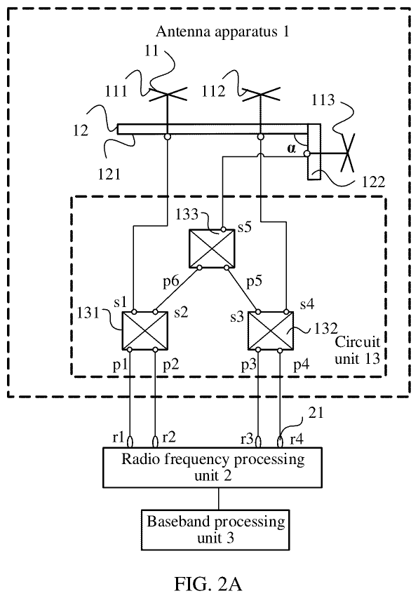

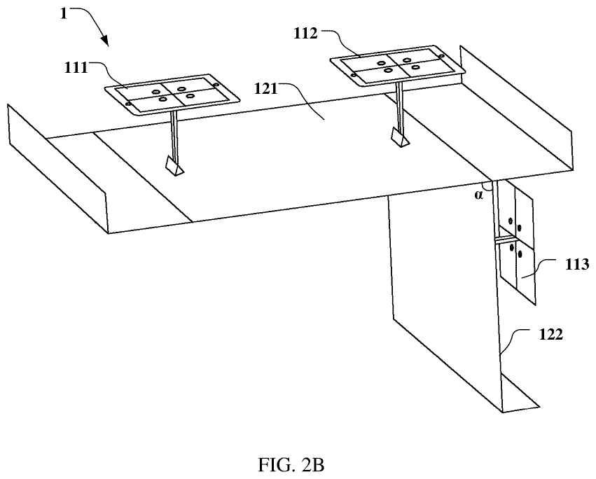

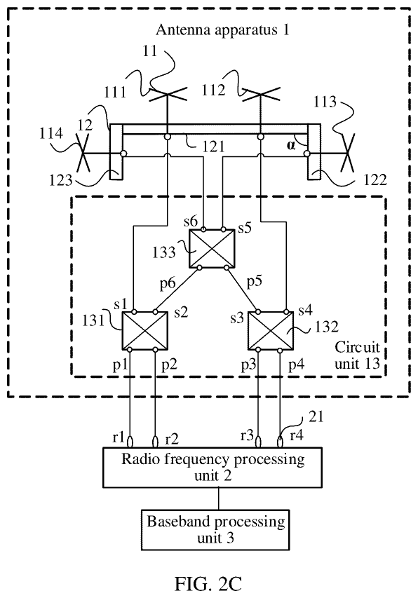

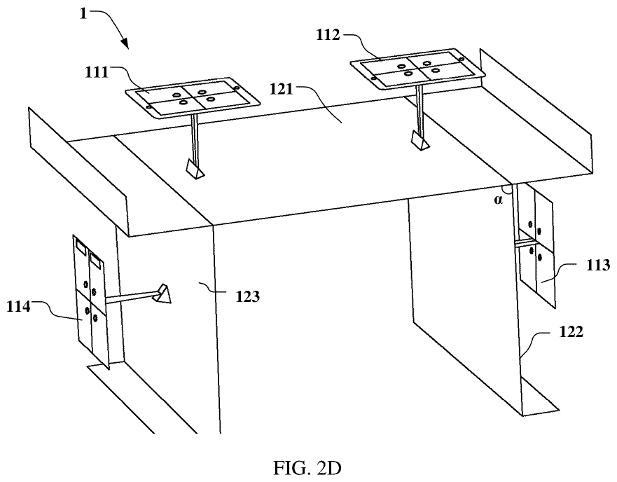

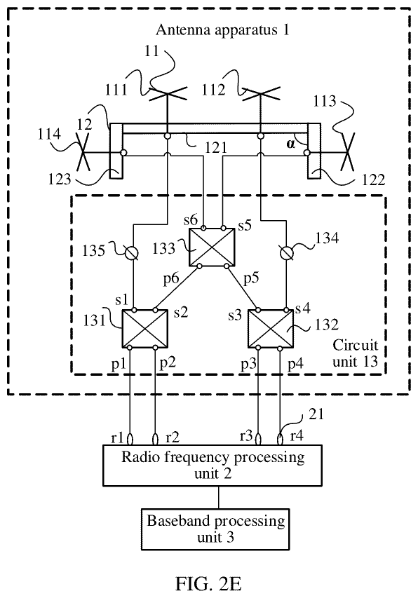

Based on the foregoing content, FIG. 2A is an example diagram of a possible structure of an access network device according to an embodiment of this application. The access network device shown in FIG. 2A may be the access network device in FIG. 1A. As shown in FIG. 2A, the access network device may include an antenna apparatus 1, a radio frequency processing unit 2, and a baseband processing unit 3.

As shown in FIG. 2A, the antenna apparatus 1 may include a plurality of radiating element arrays 11. FIG. 2A shows an example of three radiating element arrays 11: a radiating element array 111, a radiating element array 112, and a radiating element array 113.

It should be noted that, in this embodiment of this application, one radiating element array 11 may include one or more radiating elements. A division manner of the radiating element array 11 is not limited. For example, a plurality of radiating elements on one installation surface are arranged in a matrix, and one column of radiating elements is one radiating element array 11. For another example, two adjacent columns of radiating elements are one radiating element array 11. For another example, radiating elements corresponding to a small matrix with several rows and several columns are one radiating element array 11. Quantities of radiating elements in two radiating element arrays may be the same or different, and sizes of the two radiating element arrays may be the same or different. This is not limited in this embodiment of this application. The radiating element in the radiating element array 11 may also be referred to as an antenna element, an element, or the like.

As shown in FIG. 2A, the antenna apparatus 1 in this embodiment of this application may include a plurality of installation surfaces 12. The installation surfaces 12 in this embodiment of this application are configured to install the plurality of radiating element arrays 11. FIG. 2A shows an example of two installation surfaces 12: an installation surface 121 and an installation surface 122. The radiating element array 111 and the radiating element array 112 are disposed on the installation surface 121, and the radiating element array 113 is disposed on the installation surface 122. An included angle between the installation surface 121 and the installation surface 122 on a side that is away from the radiating element array 111 is less than 180°. In FIG. 2A, the included angle between the installation surface 121 and the installation surface 122 on the side that is away from the radiating element array 111 is denoted as α. FIG. 2A shows an example in which α is 90 degrees. In actual application, the included angle only needs to be less than 180 degrees, for example, may be 75 degrees or 45 degrees.

It should be noted that, in this embodiment of this application, the radiating element arrays 11 installed on the installation surfaces 12 are connected to antenna ports. In actual application, a connection manner between an antenna port and a radiating element array is flexible. This is not limited in this embodiment of this application. To facilitate understanding of the solution provided in this embodiment of this application, a radiating element array connected to one antenna port is referred to as one radiating element array in this embodiment of this application. The antenna port in this embodiment of this application may be a physical antenna port, or may be a logical antenna port. One logical antenna port may include one or more physical antenna ports. When the antenna apparatus 1 includes a plurality of installation surfaces, compared with an antenna apparatus including one installation surface, each of the plurality of installation surfaces is deployed with a radiating element array, so that more radiating element arrays can be introduced, and each installation surface can transmit an electromagnetic signal, so that an antenna diameter and an antenna area of the antenna apparatus 1 can be equivalently expanded, thereby improving a coverage area of the antenna apparatus 1 without increasing wind load and installation space. In this embodiment of this application, the antenna area may be referred to as an antenna aperture, an antenna array area, or the like, and may be specifically a region covered by radiating elements of the antenna apparatus 1.

As shown in FIG. 2A, the antenna apparatus in this embodiment of this application includes a circuit unit 13. The circuit unit 13 includes at least three bridges. FIG. 2A shows an example in which the circuit unit 13 includes a bridge 131, a bridge 132, and a bridge 133. One end of the circuit unit 13 may be connected to an antenna port, and another end may be connected to a radio frequency port 21 on the radio frequency processing unit 2. FIG. 2A shows an example of four radio frequency ports: a radio frequency port r1, a radio frequency port r2, a radio frequency port r3, and a radio frequency port r4.

It should be noted that bridges (for example, a first bridge, a second bridge, a third bridge, the bridge 131, the bridge 132, and the bridge 133) mentioned in this embodiment of this application may also be referred to as other names, for example, may be referred to as couplers. The bridges (for example, the first bridge, the second bridge, the third bridge, the bridge 131, the bridge 132, and the bridge 133) mentioned in this embodiment of this application may alternatively be other components that can implement a bridge function in this embodiment of this application. This is not limited in this embodiment of this application. For ease of understanding, the bridges are used as an example for description in this embodiment of this application.

As shown in FIG. 2A, the bridge 131 includes an input port p1 and an input port p2, the input port p1 is connected to the radio frequency port r1, and the input port p2 is connected to the radio frequency port r2. An output end of the bridge 131 includes two ports: an output port s1 and an output port s2. The output port s1 is connected to N1 radiating element arrays. N1 is a positive integer. FIG. 2A shows an example in which N1 is 1. The output port s1 is connected to the radiating element array 111 (or in other words, the output port s1 is connected to an antenna port connected to the radiating element array 111), and the output port s2 is connected to an input port p6 of the bridge 133. In this embodiment of this application, an input port of a device may also be referred to as a port at an input end, and an output port of a device may also be referred to as a port at an output end.

The input port p1 of the bridge 131 may receive a signal from the radio frequency port r1, and the input port p2 of the bridge 131 may receive a signal from the radio frequency port r2. Power of the signals received by the input port p1 and the input port p2 may be concentrated on a signal output by one output port (the output port s1 or the output port s2) of the bridge 131. When the power of the signals received by the input port p1 and the input port p2 is concentrated on a signal output by the output port s1, it is equivalent to that the power of the signals received by the input port p1 and the input port p2 may be concentrated on a signal sent by the radiating element array 111 connected to the output port s1. When the power of the signals received by the input port p1 and the input port p2 is concentrated on a signal output by the output port s2, it is equivalent to that the power of the signals received by the input port p1 and the input port p2 may be concentrated on a signal received by the input port p6, connected to the output port s2, of the bridge 133.

For example, the bridge 131 is a 90-degree bridge, and a power ratio of the bridge 131 is 1:1. In this case, when signals from the radio frequency port r1 and the radio frequency port r2 have a phase difference of 90 degrees and have equal amplitudes (a power ratio is 1:1), power of signals received by the input port p1 and the input port p2 may be concentrated on a signal output by one output port (the output port s1 or the output port s2) of the bridge 131. For example, a phase of a signal sent by the radio frequency port r1 lags 90 degrees behind a phase of a signal sent by the radio frequency port r2, and the signal sent by the radio frequency port r1 has an equal amplitude as the signal sent by the radio frequency port r2. In this case, power of the signal sent by the radio frequency port r1 and the signal sent by the radio frequency port r2 is concentrated on a signal output by the output port s1. For another example, a phase of a signal sent by the radio frequency port r2 lags 90 degrees behind a phase of a signal sent by the radio frequency port r1, and the signal sent by the radio frequency port r1 has an equal amplitude as the signal sent by the radio frequency port r2. In this case, power of the signal sent by the radio frequency port r1 and the signal sent by the radio frequency port r2 is concentrated on a signal output by the output port s2.

It should be noted that, in a possible example, when signals received by two input ports of the bridge in this embodiment of this application have a phase difference of 90 degrees and have equal amplitudes, power of the signals received by the two input ports of the bridge may be concentrated on a signal sent by one output port of the bridge. With development of technologies, a function or a parameter of the bridge may change, and a condition under which power of signals received by the two input ports of the bridge may be concentrated on one output port of the bridge may also change, for example, may change to “the signals received by the two input ports of the bridge have a phase difference of 180 degrees and have equal amplitudes”. This is not limited in this embodiment of this application.

As shown in FIG. 2A, the bridge 132 includes an input port p3 and an input port p4, the input port p3 is connected to the radio frequency port r3, and the input port p4 is connected to the radio frequency port r4. An output end of the bridge 132 includes two ports: an output port s3 and an output port s4. The output port s3 is connected to an input port p5 of the bridge 133. The output port s4 is connected to N2 radiating element arrays. N2 is a positive integer. FIG. 2A shows an example in which N2 is 1. The output port s4 is connected to the radiating element array 112 (or in other words, the output port s4 is connected to an antenna port connected to the radiating element array 112).

The input port p4 of the bridge 132 may receive a signal from the radio frequency port r4, and the input port p3 of the bridge 132 may receive a signal from the radio frequency port r3. Power of the signals received by the input port p4 and the input port p3 may be concentrated on a signal output by one output port (the output port s4 or the output port s3) of the bridge 132. When the power of the signals received by the input port p4 and the input port p3 is concentrated on a signal output by the output port s4, it is equivalent to that the power of the signals received by the input port p4 and the input port p3 may be concentrated on a signal sent by the radiating element array 112 connected to the output port s4. When the power of the signals received by the input port p4 and the input port p3 are concentrated on a signal output by the output port s3, it is equivalent to that the power of the signals received by the input port p4 and the input port p3 may be concentrated on a signal received by the input port p5, connected to the output port s3, of the bridge 133.

For example, the bridge 132 is a 90-degree bridge. In this case, when signals from the radio frequency port r4 and the radio frequency port r3 have a phase difference of 90 degrees and have equal amplitudes, power of signals received by the input port p4 and the input port p3 may be concentrated on a signal output by one output port (the output port s4 or the output port s3) of the bridge 132. For example, a phase difference between a signal sent by the radio frequency port r3 and a signal sent by the radio frequency port r4 may be controlled to control power of signals received by the input port p4 and the input port p3 to be concentrated on which output port (the output port s4 or the output port s3) of the bridge 132. For a specific example, refer to related descriptions of the bridge 131. Details are not described herein again.

Still refer to FIG. 2A. The input port p6 of the bridge 133 may receive a signal output by the output port s2 of the bridge 131, and the input port p5 of the bridge 133 may receive a signal output by the output port s3 of the bridge 132. The output port s5 is connected to N3 radiating element arrays. N3 is a positive integer. FIG. 2A shows an example in which N3 is 1. The output port s5 is connected to the radiating element array 113 (or in other words, the output port s5 is connected to an antenna port connected to the radiating element array 113).

When signals from the output port s2 and the output port s3 meet a specific condition (for example, the signals from the output port s2 and the output port s3 have a phase difference of 90 degrees and have equal amplitudes), power of signals received by the output port s2 and the output port s3 may be concentrated on a signal output by one output port (for example, the output port s5 shown in FIG. 2A) of the bridge 133. When the power of the signals received by the output port s2 and the output port s3 is concentrated on the signal output by the output port s5, it is equivalent to that the power of the signals received by the output port s2 and the output port s3 may be concentrated on a signal sent by the radiating element array 113 connected to the output port s5.

For example, the bridge 131 is a 90-degree bridge, and signals from the radio frequency port r1 and the radio frequency port r2 have a phase difference of 90 degrees and have equal amplitudes. In this case, power of signals received by the input port p1 and the input port p2 may be concentrated on a signal output by the output port s2 of the bridge 131.

The bridge 132 is a 90-degree bridge. When signals from the radio frequency port r4 and the radio frequency port r3 have a phase difference of 90 degrees and have equal amplitudes, power of signals received by the input port p4 and the input port p3 may be concentrated on a signal output by the output port s3 of the bridge 132.

The bridge 133 is a 90-degree bridge. When signals from the output port s2 and the output port s3 have a phase difference of 90 degrees and have equal amplitudes, power of signals received by the input port p6 and the input port p5 may be concentrated on a signal output by one output port (for example, the output port s5) of the bridge 133. For example, a phase difference between a signal sent by the output port s2 and a signal sent by the output port s3 may be controlled to control power of signals received by the input port p6 and the input port p5 to be concentrated on which output port (an output port s6 or the output port s5) of the bridge 133. For a specific example, refer to related descriptions of the bridge 131. Details are not described herein again.

It should be noted that, FIG. 2A shows an example in which an output end of the bridge 133 includes one output port s5. In actual application, the output end of the bridge 133 may alternatively include a plurality of ports. This is not limited in this embodiment of this application.

In this embodiment of this application, if an output port of a bridge is not connected to a component such as an antenna, a bridge, or a power divider, to avoid a circuit burnout or the like, this embodiment of this application may provide a circuit protection measure, for example, connecting, to a load, the output port of the bridge that is not connected to a component such as an antenna, a bridge, or a power divider.

In this embodiment of this application, a parameter of the bridge (the first bridge, the second bridge, or the third bridge) may be flexibly configured based on a requirement. For example, the bridge may be a 90-degree bridge or a 180-degree bridge. In this embodiment of this application, for example, the bridge (the first bridge, the second bridge, or the third bridge) is a 90-degree bridge.

In this embodiment of this application, a quantity of input ports and a quantity of output ports of the bridge may also be flexibly set. In this embodiment of this application, an example in which the bridge includes two input ports and two output ports is used for description. In actual application, the quantity of input ports and the quantity of output ports may be flexibly set based on an actual scenario. For example, the bridge may include three or more input ports, so that the bridge can receive signals from more radio frequency ports.

For example, the bridge 131 in FIG. 2A may include three input ports, and the three input ports are respectively connected to three radio frequency ports. The bridge 131 includes three output ports, and the three output ports of the bridge 131 may be respectively connected to radiating element arrays on three installation surfaces. The bridge 131 may allocate power of signals received by the three input ports to one output port. In this way, when an installation surface is in a working state, the bridge 131 may concentrate power of signals received by the three input ports onto an output port connected to a radiating element array on the installation surface in a working state, so that a power waste can be reduced by using the bridge 131.

In this embodiment of this application, a power ratio of the bridge may be flexibly set based on a requirement, for example, may be set to 2:1 or 1:1. In this embodiment of this application, an example in which the power ratio of the bridge is 1:1 is used for description. That the power ratio of the bridge in this embodiment of this application is 1:1 may be understood as that for a signal input by one input port of the bridge, a power ratio of signals output by two output ports is 1:1. If the bridge is a 90-degree bridge, when a power ratio of signals input by the two input ports of the bridge is 1:1, and the signals input by the two input ports have a phase difference of 90 degrees, power of the signals input by the two input ports of the bridge may be concentrated on a signal output by one radio frequency port. In this way, a power waste can be reduced.

Similarly, when the power ratio of the bridge is 2:1, if the bridge is a 90-degree bridge, when a power ratio of signals input by the two input ports of the bridge is 2:1, and the signals input by the two input ports have a phase difference of 90 degrees, power of the signals input by the two input ports of the bridge may be concentrated on a signal output by one radio frequency port. In this way, a power waste can be reduced.

In a possible implementation, output power that can be supported by a plurality of power amplifiers connected to the plurality of input ports of the bridge may be equal. Therefore, when the power ratio of the bridge is 1:1, the plurality of power amplifiers connected to the plurality of input ports can all transmit signals at the output power supported by the plurality of power amplifiers. In this way, a power ratio of two input signals of the bridge can be 1:1, thereby reducing a power waste. In addition, when the plurality of power amplifiers transmit signals at the output power that can be supported by the plurality of power amplifiers, power underrun can be alleviated.

It can be learned from the foregoing content that, because a first radio frequency port, a second radio frequency port, a third radio frequency port, and a fourth radio frequency port may be connected to the N1 radiating element arrays, the N2 radiating element arrays, and the N3 radiating element arrays by using the first bridge unit, power sharing may be implemented between the radiating element arrays, and power of each array may be adjusted based on a requirement.

Further, the power of the signals received by the input port p1 and the input port p2 may be concentrated on the signal output by the output port s1 of the bridge 131, that is, the power of the signals received by the input port p1 and the input port p2 may be concentrated on the signal sent by the radiating element array 111 connected to the output port s1. For example, in a possible example, the power of the signals received by the input port p1 and the input port p2 may be all concentrated on the signal sent by the radiating element array 111 connected to the output port s1.

In addition, the power of the signals received by the input port p4 and the input port p3 may be concentrated on the signal output by the output port s4 of the bridge 132, that is, the power of the signals received by the input port p4 and the input port p3 may be concentrated on the signal sent by the radiating element array 112 connected to the output port s4. For example, in a possible example, the power of the signals received by the input port p4 and the input port p3 may be all concentrated on the signal sent by the radiating element array 112 connected to the output port s4.

Therefore, when the radiating element arrays (for example, the radiating element array 111 and the radiating element array 112) deployed on the installation surface 121 of the antenna apparatus 1 are in a working state, while the radiating element arrays (for example, the radiating element array 113) deployed on the installation surface 122 of the antenna apparatus 1 are not in a working state, power of signals sent by the radio frequency port r1 and the radio frequency port r2 may be concentrated on the radiating element array 111 deployed on the installation surface 121, power of signals sent by the radio frequency port r3 and the radio frequency port r4 may be concentrated on the radiating element array 112 deployed on the installation surface 121, so that power utilization can be improved, and a power waste can be reduced.

In a possible implementation, each of the N2 radiating element arrays is different from each of the N1 radiating element arrays. When the radiating element arrays (for example, the radiating element array 111 and the radiating element array 112) deployed on the installation surface 121 of the antenna apparatus 1 are in a working state, while the radiating element arrays (for example, the radiating element array 113) deployed on the installation surface 122 of the antenna apparatus 1 are not in a working state, a logical port formed by the radio frequency port r1 and the radio frequency port r2 and a logical port formed by the radio frequency port r3 and the radio frequency port r4 may not interfere with each other in an analog circuit. To be specific, power and phases of signals sent by the radio frequency port r1 and the radio frequency port r2 are set based on a requirement of the radiating element array 111. Power and phases of signals sent by the radio frequency port r3 and the radio frequency port r4 are set based on a requirement of the radiating element array 112. Therefore, power amplifiers (for example, a power amplifier connected to the radio frequency port r1, a power amplifier connected to the radio frequency port r2, a power amplifier connected to the radio frequency port r3, and a power amplifier connected to the radio frequency port r4) connected to radio frequency ports at a radio frequency front-end of the radio frequency processing unit 2 can send signals at output power supported by the power amplifiers, so that a problem that a power amplifier connected to a radio frequency port cannot send a signal at output power supported by the power amplifier can be avoided, thereby reducing a power waste caused by power overrun. That a power amplifier connected to a radio frequency port cannot send a signal at output power supported by the power amplifier may also be referred to as power overrun. It can be learned that the solution provided in this embodiment of this application can avoid power overrun of the power amplifier.

Further, because the solution provided in this embodiment of this application can resolve the power overrun problem of the power amplifier, that is, the power amplifiers connected to the radio frequency ports can send signals at output power supported by the power amplifiers, compared with a solution in which a power amplifier connected to a radio frequency port cannot send a signal at output power supported by the power amplifier, the solution provided in this embodiment of this application can increase an amplitude of a level of a signal received by a terminal device, thereby improving coverage performance of the antenna apparatus.

In addition, the power of the signals received by the input port p1 and the input port p2 may be concentrated on the signal output by the output port s2 of the bridge 131. The power of the signals received by the input port p4 and the input port p3 may be concentrated on the signal output by the output port s3 of the bridge 132. The power of the signals received by the output port s2 and the output port s3 may be concentrated on the signal output by the output port s5 of the bridge 133.

Therefore, when the radiating element arrays (for example, the radiating element array 111 and the radiating element array 112) deployed on the installation surface 121 of the antenna apparatus 1 are not in a working state, while the radiating element arrays (for example, the radiating element array 113) deployed on the installation surface 122 of the antenna apparatus 1 are in a working state, power of signals sent by the radio frequency port r1, the radio frequency port r2, the radio frequency port r3, and the radio frequency port r4 may be concentrated on the radiating element array 113 deployed on the installation surface 122, so that power utilization can be improved, and a power waste can be reduced.

In addition, as shown in FIG. 2A, in this embodiment of this application, the power of the signals sent by the radio frequency port r1, the radio frequency port r2, the radio frequency port r3, and the radio frequency port r4 may alternatively be allocated among the radiating array 111, the radiating element array 112, and the radiating element array 113 based on a requirement. The circuit unit in this embodiment of this application has a simple structure and low complexity.

The access network device provided in this embodiment of this application may further include another component, for example, may further include the radio frequency processing unit 2 and the baseband processing unit shown in FIG. 2A. FIG. 2A shows an example in which the radio frequency processing unit 2 is connected to the baseband processing unit 3. The radio frequency processing unit 2 may be configured to perform frequency selection, amplification, and down-conversion processing on a signal received by using the radiating element array 11, convert the signal into an intermediate frequency signal or a baseband signal, and send the intermediate frequency signal or the baseband signal to the baseband processing unit 3. Alternatively, the radio frequency processing unit 2 is configured to perform up-conversion and amplification processing on an intermediate frequency signal or a baseband signal sent by the baseband processing unit 3 and send the intermediate frequency signal or the baseband signal by using the radiating element array 11.

In some implementations, the radio frequency processing unit 2 may also be referred to as a remote radio unit (RRU) or may be a radio frequency module in an active antenna unit (AAU). The baseband processing unit 3 may also be referred to as a baseband unit (BBU). The antenna apparatus in this embodiment of this application may be a passive antenna. The antenna apparatus in this embodiment of this application may be installed on a pole. For example, the antenna apparatus has a back side connected to the pole, and a front side provided with the radiating element arrays. The access network device performs electromagnetic radiation by using the antenna to transmit a signal. The RRU in the access network device may be installed on a pole, or may be installed under a pole.

It should be noted that FIG. 2A shows an example of a quantity of radiating elements included on one installation surface. In actual application, a quantity of antenna ports may be expanded in a horizontal dimension and/or a vertical dimension. This is not limited in this embodiment of this application.

A first installation surface and a second installation surface in this embodiment of this application may be two different installation surfaces. For example, the first installation surface may be the installation surface 121, and the second installation surface may be the installation surface 122. The N1 radiating element arrays may include the radiating element array 111. The N2 radiating element arrays may include the radiating element array 112. The N3 radiating element arrays may include the radiating element array 113. A first included angle in this embodiment of this application may be the included angle denoted as α in FIG. 2A.

The first bridge in this embodiment of this application may be the bridge 131, a first input port of the first bridge may be the input port p1 of the bridge 131, a second input port of the first bridge may be the input port p2 of the bridge 131, a first output port of the first bridge may be the output port s1 of the bridge 131, and a second output port of the first bridge may be the output port s2 of the bridge 131.

The second bridge in this embodiment of this application may be the bridge 132, a third input port of the second bridge may be the input port p3 of the bridge 132, a fourth input port of the second bridge may be the input port p4 of the bridge 132, a third output port of the second bridge may be the output port s4 of the bridge 132, and a fourth output port of the second bridge may be the output port s3 of the bridge 132.

The third bridge in this embodiment of this application may be the bridge 133, a fifth input port of the third bridge may be the input port p6 of the bridge 133, a sixth input port of the third bridge may be the input port p5 of the bridge 133, and a fifth output port of the third bridge may be the output port s5 of the bridge 133.

The first radio frequency port may be the radio frequency port r1, the second radio frequency port may be the radio frequency port r2, the third radio frequency port may be the radio frequency port r3, and the fourth radio frequency port may be the radio frequency port r4.

In this embodiment of this application, an installation surface on which the N1 radiating element arrays and the N2 radiating element arrays are installed is referred to as a first installation surface, and an installation surface on which the N3 radiating element arrays are installed is referred to as a second installation surface. The first installation surface and the second installation surface are not located in a same plane, but are located on two different installation surfaces with the first included angle. For specific wind load, in this embodiment of this application, a larger quantity of radiating element arrays may be disposed, so that a coverage area of the antenna apparatus can be improved, and performance of the antenna apparatus can be improved.

In this embodiment of this application, the first installation surface may be one surface (plane or curved surface), or a combination of a plurality of surfaces (planes or curved surfaces). For example, the first installation surface includes two surfaces. The N1 radiating element arrays are disposed on one surface (plane or curved surface), and the N2 radiating element arrays are disposed on the other surface (plane or curved surface). There may be a specific included angle between the two planes. In another possible example, the N1 radiating element arrays may alternatively be deployed on a plurality of surfaces, and the N2 radiating element arrays may also be deployed on one or more surfaces. Similarly, the second installation surface may be one surface (plane or curved surface), or a combination of a plurality of surfaces (planes or curved surfaces), and the N3 radiating element arrays are disposed on one or more surfaces (planes or curved surfaces) included in the second installation surface.

Based on the access network device shown in FIG. 2A and the foregoing other content, FIG. 2B is a diagram of a possible structure of a part of components in the antenna apparatus 1 according to an embodiment of this application. As shown in FIG. 2B, the first installation surface 121 is located on one installation board, and the second installation surface 122 is located on another installation board. The two installation boards may be connected in a manner of welding, threaded connection, integrated molding, or the like.

In a possible implementation, the installation board on which the first installation surface 121 is disposed may include a reflective sheet. For example, the installation board on which the first installation surface 121 is disposed is coated to prepare the reflective sheet, or the installation board on which the first installation surface 121 is disposed is the reflective sheet. Specifically, the installation board on which the first installation surface 121 is disposed may be made of a metal (for example, aluminum) material, so that the installation board on which the first installation surface 121 is disposed is used as the reflective sheet.

In another possible implementation, the installation board on which the second installation surface 122 is disposed may include a reflective sheet. For example, the installation board on which the second installation surface 122 is disposed is coated to prepare the reflective sheet, or the installation board on which the second installation surface 122 is disposed is the reflective sheet. Specifically, the installation board on which the second installation surface 122 is disposed may be made of a metal (for example, aluminum) material, so that the installation board on which the second installation surface 122 is disposed is used as the reflective sheet. When the antenna apparatus 1 sends a signal, the reflective sheet may reflect the antenna signal to a target coverage region. When the antenna receives a signal, the reflective sheet may reflect, to a radiating element array in the antenna apparatus, a signal transmitted to the reflective sheet, so that the radiating element array receives the signal. The reflective sheet may also be referred to as a bottom board, an antenna panel, a reflective surface, or the like.

Based on the embodiments shown in FIG. 2A and FIG. 2B and other content, FIG. 2C shows an example diagram of another possible structure of the access network device. A difference from FIG. 2A is that the antenna apparatus 1 in the access network device shown in FIG. 2C further includes an installation surface 123, and a radiating element array 114 is further deployed on the installation surface 123. The radiating element array 114 is connected to the output port s6 of the bridge 133. The installation surface 123 and the installation surface 122 are located on two opposite sides of the installation surface 121.

Power of signals received by the output port s2 and the output port s3 may be concentrated on a signal output by one output port (for example, the output port s5 or the output port s6 shown in FIG. 2A) of the bridge 133. When the power of the signals received by the output port s2 and the output port s3 is concentrated on a signal output by the output port s6, it is equivalent to that the power of the signals received by the output port s2 and the output port s3 may be concentrated on a signal sent by the radiating element array 114 connected to the output port s6.

For example, the bridge 131 is a 90-degree bridge, and signals from the radio frequency port r1 and the radio frequency port r2 have a phase difference of 90 degrees and have equal amplitudes. In this case, power of signals received by the input port p1 and the input port p2 may be concentrated on a signal output by the output port s2 of the bridge 131.

The bridge 132 is a 90-degree bridge. When signals from the radio frequency port r4 and the radio frequency port r3 have a phase difference of 90 degrees and have equal amplitudes, power of signals received by the input port p4 and the input port p3 may be concentrated on a signal output by the output port s3 of the bridge 132.

The bridge 133 is a 90-degree bridge. When signals from the output port s2 and the output port s3 have a phase difference of 90 degrees and have equal amplitudes, power of signals received by the input port p6 and the input port p5 may be concentrated on a signal output by one output port (for example, the output port s6) of the bridge 133.

It can be learned from the foregoing content that, when the radiating element array 114 on the installation surface 123 is in a working state, while radiating element arrays such as the radiating element array 111, the radiating element array 112, and the radiating element array 113 on other installation surfaces are not in a working state, power of signals sent by the radio frequency port r1, the radio frequency port r2, the radio frequency port r3, and the radio frequency port r4 may be concentrated on the radiating element array 114 deployed on the installation surface 123 (for example, in a possible example, the power of the signals sent by the radio frequency port r1, the radio frequency port r2, the radio frequency port r3, and the radio frequency port r4 may be all concentrated on the radiating element array 114 deployed on the installation surface 123). The antenna apparatus 1 shown in FIG. 2C may implement 360-degree coverage. To be specific, because one antenna apparatus includes a plurality of installation surfaces, and different installation surfaces cover different regions, one antenna apparatus may implement omnidirectional 360-degree coverage. It may also be understood as that one antenna apparatus 1 may cover a large quantity of cells. In addition, when a radiating element array of one cell is not in a working state, a radiating element array of another cell is not affected and can keep working.

It should be noted that a third installation surface in this embodiment of this application may be the installation surface 123, and N4 radiating element arrays may include the radiating element array 114. The third installation surface and the second installation surface are located on two opposite sides of the first installation surface. In this embodiment of this application, an included angle between the first installation surface and the third installation surface on a side that is away from the N1 radiating element arrays is a second included angle. The second included angle may or may not be equal to the first included angle. This is not limited in this embodiment of this application. The second included angle is less than 180 degrees. The third bridge in this embodiment of this application may be the bridge 133, and a sixth output port of the third bridge may be the output port s6 of the bridge 133.

In this embodiment of this application, an installation surface on which the N4 radiating element arrays are installed is referred to as a third installation surface. In a possible implementation, the first installation surface and the third installation surface are not located in a same plane, but are two different installation surfaces with an included angle. The included angle may or may not be equal to the first included angle. For specific wind load, in this embodiment of this application, a larger quantity of radiating element arrays may be disposed, so that a coverage area of the antenna apparatus can be improved, and performance of the antenna apparatus can be improved.

In this embodiment of this application, the third installation surface may be one surface (plane or curved surface), or a combination of a plurality of surfaces (planes or curved surfaces), and the N4 radiating element arrays are disposed on one or more surfaces (planes or curved surfaces) included in the third installation surface.

Based on the access network device shown in FIG. 2C and the foregoing other content, FIG. 2D is a diagram of a possible structure of a part of components in the antenna apparatus 1 according to an embodiment of this application. As shown in FIG. 2D, the first installation surface 121 is located on one installation board, the second installation surface 122 is located on another installation board, and the third installation surface 123 is located on another installation board. The installation board on which the third installation surface 123 is disposed and the installation board on which the first installation surface 121 is disposed may be connected in a manner of welding, threaded connection, integrated molding, or the like. As shown in FIG. 2D, in a possible implementation, the installation board on which the third installation surface 123 is disposed and the installation board on which the second installation surface 122 is disposed may be located on two opposite sides of the installation board on which the first installation surface 121 is disposed.

In a possible implementation, the installation board on which the third installation surface 123 is disposed may include a reflective sheet. For example, the installation board on which the third installation surface 123 is disposed is coated to prepare the reflective sheet, or the installation board on which the third installation surface 123 is disposed is the reflective sheet. Specifically, the installation board on which the third installation surface 123 is disposed may be made of a metal (for example, aluminum) material, so that the installation board on which the third installation surface 123 is disposed is used as the reflective sheet. When the antenna apparatus 1 sends a signal, the reflective sheet may reflect the antenna signal to a target coverage region. When the antenna receives a signal, the reflective sheet may reflect, to a radiating element array in the antenna apparatus, a signal transmitted to the reflective sheet, so that the radiating element array receives the signal. The reflective sheet may also be referred to as a bottom board, an antenna panel, a reflective surface, or the like.

A microstrip may be further disposed in the circuit unit of the antenna apparatus 1 provided in this embodiment of this application, and the microstrip may be configured to align phases of outbound interfaces of the circuit unit. For example, the antenna apparatus further includes a first microstrip, and the first bridge is connected to the N1 radiating element arrays by using the first microstrip. The first microstrip may be configured to adjust a phase of a received signal, so that adjustability of the antenna apparatus in an actual application scenario can be improved.

In a possible implementation, the first microstrip is configured to delay, by a first preset value, a phase of a signal output by the first output port of the first bridge. For example, the first preset value may be determined based on a phase difference between the phase of the signal output by the first output port of the first bridge and a phase of a signal received by the N3 radiating element arrays.

For example, when the second output port of the first bridge is connected to a radiating element array by using the third bridge, because a phase of a signal output by the third bridge is 90 degrees deflected from a phase of a signal output by the first bridge, the first microstrip may be configured to delay, by 90 degrees, the phase of the signal output by the first output port of the first bridge (that is, the first preset value is 90 degrees). For another example, if the phase of the signal received by the N3 radiating element arrays connected to the third bridge is 180 degrees deflected from the phase of the signal output by the first bridge, the first preset value may be 180 degrees. In this way, the phase, adjusted by the first microstrip, of the signal may be aligned with a phase of a signal output by an output port of the third bridge. Further, a phase of a signal received by a radiating element array connected to the first microstrip may be aligned with a phase of a signal received by a radiating element array connected to the second output port of the first bridge, and then the radiating element arrays may output phase-aligned signals, thereby improving signal strength.

For another example, the antenna apparatus further includes a second microstrip, and the second bridge is connected to the N2 radiating element arrays by using the second microstrip. The second microstrip may be configured to adjust a phase of a received signal, so that adjustability of the antenna apparatus in an actual application scenario can be improved.

In a possible implementation, the second microstrip is configured to delay, by a second preset angle, a phase of a signal output by the third output port of the second bridge. For example, the second preset angle may be determined based on a phase difference between the phase of the signal output by the third output port of the second bridge and the phase of the signal received by the N3 radiating element arrays.

For example, when the fourth output port of the second bridge is connected to a radiating element array by using the third bridge, because a phase of a signal output by the third bridge is 90 degrees deflected from a phase of a signal output by the second bridge, the second microstrip may be configured to delay, by 90 degrees, the phase of the signal output by the third output port of the second bridge (that is, the second preset angle is 90 degrees). For another example, if the phase of the signal received by the N3 radiating element arrays connected to the third bridge is 180 degrees deflected from the phase of the signal output by the second bridge, the second preset angle may be 180 degrees. In this way, the phase, adjusted by the second microstrip, of the signal may be aligned with a phase of a signal output by an output port of the third bridge, a phase of a signal received by a radiating element array connected to the second microstrip may be aligned with a phase of a signal received by a radiating element array connected to the fourth output port of the second bridge, and then the radiating element arrays may output phase-aligned signals, thereby improving signal strength.

Based on the access network devices shown in FIG. 2A, FIG. 2B, FIG. 2C, and FIG. 2D and other content, FIG. 2E shows an example diagram of another possible structure of the access network device. The structure of the access network device shown in FIG. 2E may be considered as an extended embodiment of the embodiment shown in FIG. 2C. A difference from FIG. 2C is that a circuit unit 13 in the access network device shown in FIG. 2E includes a microstrip 134 and a microstrip 135. The microstrip 134 may be configured to adjust a phase of a signal output by the output port s4. The microstrip 135 may be configured to adjust a phase of a signal output by the output port s1. In actual application, phases of signals output by four outbound interfaces (an outbound interface connected to the output port s1, an outbound interface connected to the output port s5, an outbound interface connected to the output port s6, and an outbound interface connected to the output port s4) of the circuit unit 13 may be aligned. Because the outbound interface connected to the output port s5 and the outbound interface connected to the output port s6 are further connected to the bridge 133, the output port s1 and the output port s4 are each additionally connected to a microstrip. Because a phase of a signal output by the bridge 133 is 90 degrees deflected from a phase of a signal output by the output port s1 (or the output port s4), the microstrip may be a microstrip that delays a phase by 90 degrees, so that the phases of the signals output by the four interfaces are aligned, and then radiating element arrays may output phase-aligned signals, thereby improving signal strength.

The microstrip 134 may be another connecting line, such as a transmission line or a coaxial line, that can achieve a same effect. The microstrip 134 is a microstrip that delays a phase by a first preset value, and the first preset value may be, for example, the foregoing 90 degrees, or may be another angle. The microstrip 135 may be another connecting line, such as a transmission line or a coaxial line, that can achieve a same effect. The microstrip 135 is a microstrip that delays a phase by a second preset angle, and the second preset angle may be, for example, the foregoing 90 degrees, or may be another angle. For example, when a phase of a signal output by one output port of the antenna apparatus is 180 degrees deflected from a phase of a signal output by another output port, the output port may be connected to a microstrip configured to deflect the phase by 180 degrees. The first microstrip in this embodiment of this application may be the microstrip 135, and the second microstrip may be the microstrip 134. The access network device shown in FIG. 2E is an improvement based on the architecture of the access network device shown in FIG. 2C. Alternatively, the architecture shown in FIG. 2E may be an improvement based on the architecture of the access network device shown in FIG. 2A. In this case, in the access network device shown in FIG. 2A, microstrips are deployed between the output port s1 and a radiating element array and between the output port s4 and a radiating element array. For other content, refer to the foregoing content. Details are not described again.

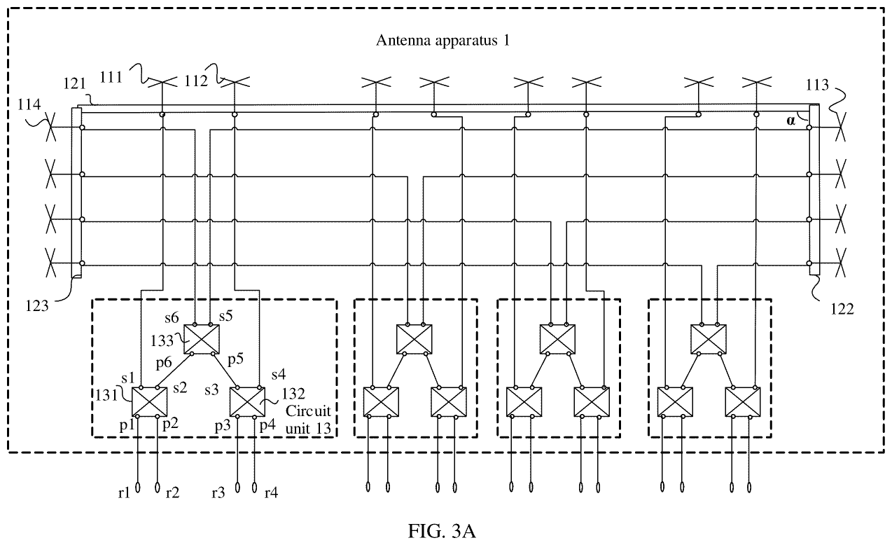

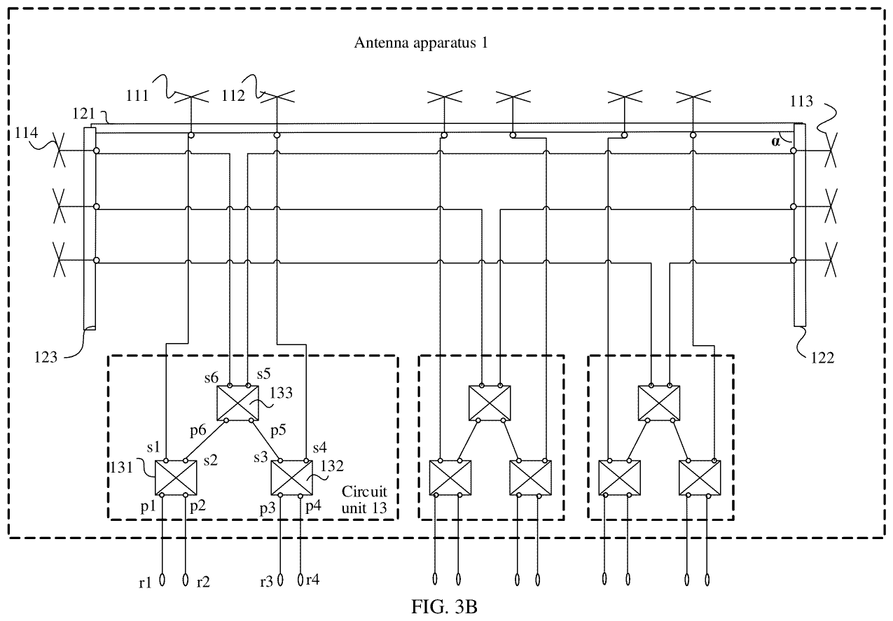

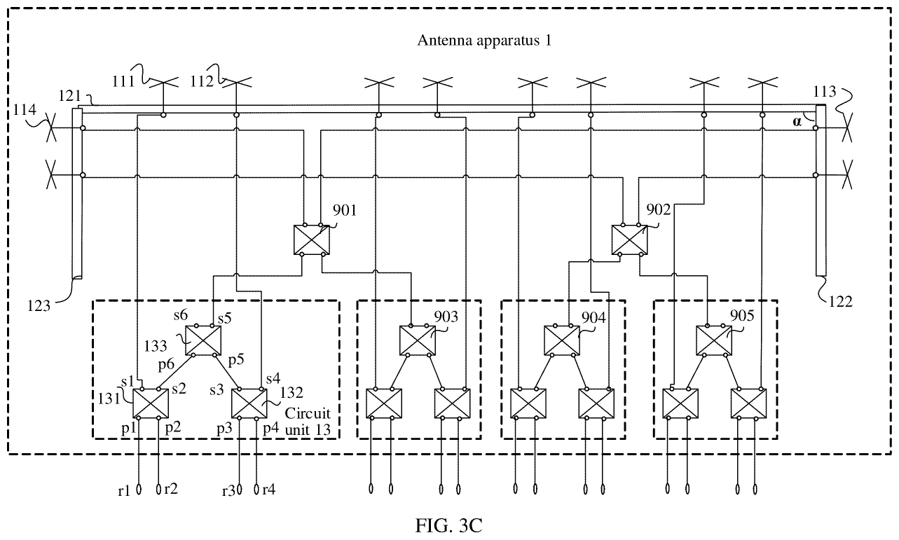

Based on the embodiments shown in FIG. 2A, FIG. 2B, FIG. 2C, FIG. 2D, and FIG. 2E, and other content, FIG. 3A, FIG. 3B, and FIG. 3C show example diagrams of several possible structures of the antenna apparatus 1 according to an embodiment of this application. The antenna apparatus 1 provided in this embodiment of this application may include one or more circuit units 13. FIG. 3A, FIG. 3B, and FIG. 3C show examples in which the antenna apparatus 1 may include a plurality of circuit units 13.

Compared with FIG. 2C, FIG. 3A is different in that the antenna apparatus 1 shown in FIG. 3A includes four circuit units 13. One output port of a bridge 131 in each circuit unit 13 is connected to N1 radiating element arrays disposed on the installation surface 121 (FIG. 3A shows an example in which N1 is equal to 1), one output port of a bridge 132 in each circuit unit 13 is connected to N2 radiating element arrays disposed on the installation surface 121 (FIG. 3A shows an example in which N2 is equal to 1), one output port of a bridge 133 of the circuit unit 13 is connected to N3 radiating element arrays disposed on the installation surface 122 (FIG. 3A shows an example in which N3 is equal to 1), and another output port of the bridge 133 of the circuit unit 13 is connected to N4 radiating element arrays disposed on the installation surface 123 (FIG. 3A shows an example in which N4 is equal to 1). For a manner of connecting each circuit unit to radiating element arrays and radio frequency ports, refer to related descriptions of FIG. 2A and FIG. 2C. Details are not described herein again.

It can be learned from FIG. 3A that each circuit unit in this embodiment of this application is connected to four radio frequency ports. Each circuit unit is connected to (N1+N2+N3+N4) radiating element arrays. It should be noted that any two radiating element arrays connected to any two circuit units are different. It may also be understood as that one radiating element array is connected to one output port of one bridge in one circuit unit, and one output port of one bridge may be connected to one or more radiating element arrays. A spacing between two adjacent radiating element arrays on a same installation surface may be set based on an actual situation. This is not limited in this embodiment of this application.

For example, the spacing between the two adjacent radiating element arrays on the installation surface may be 57 millimeters. In this case, a total length of the installation surface 121 may be set to 500 millimeters. Such a size is merely an example, and does not constitute a limitation on this embodiment of this application.

As shown in FIG. 3A, when radiating element arrays (for example, eight radiating element arrays deployed on the installation surface 121) deployed on the installation surface 121 of the antenna apparatus 1 are in a working state, while radiating element arrays (for example, four radiating element arrays deployed on the installation surface 122) deployed on the installation surface 122 of the antenna apparatus 1 are not in a working state, and radiating element arrays (for example, four radiating element arrays deployed on the installation surface 123) deployed on the installation surface 123 of the antenna apparatus 1 are not in a working state, power of signals sent by 16 radio frequency ports shown in FIG. 3A may be concentrated on the eight radiating element arrays deployed on the installation surface 121 (for example, in a possible example, the power of the signals sent by the 16 radio frequency ports shown in FIG. 3A may be all concentrated on the eight radiating element arrays deployed on the installation surface 121), so that power utilization can be improved, and a power waste can be reduced.

Compared with FIG. 3A, FIG. 3B is different in that FIG. 3B shows an example in which the antenna apparatus 1 includes three circuit units 13. Other content is similar to content in FIG. 3A, and details are not described again.

As shown in FIG. 3B, when radiating element arrays (for example, six radiating element arrays deployed on the installation surface 121) deployed on the installation surface 121 of the antenna apparatus 1 are in a working state, while radiating element arrays (for example, three radiating element arrays deployed on the installation surface 122) deployed on the installation surface 122 of the antenna apparatus 1 are not in a working state, and radiating element arrays (for example, three radiating element arrays deployed on the installation surface 123) deployed on the installation surface 123 of the antenna apparatus 1 are not in a working state, power of signals sent by 12 radio frequency ports shown in FIG. 3B may be concentrated on the six radiating element arrays deployed on the installation surface 121, so that power utilization can be improved, and a power waste can be reduced.

Compared with FIG. 3A, FIG. 3C is different in that FIG. 3C further includes a bridge 901 and a bridge 902, the installation surface 123 includes two radiating element arrays, and the installation surface 122 includes two radiating element arrays. The output port s5 of the bridge 133 may be connected to the radiating element array 113 and the radiating element array 114 by using the bridge 901. An output port of a bridge 903 may also be connected to the radiating element array 113 and the radiating element array 114 by using the bridge 901. Output ports of the bridge 904 and the bridge 905 may be connected, by using the bridge 902, to the radiating element arrays deployed on the installation surface 122 and the installation surface 123. Other content is similar to content in FIG. 3A, and details are not described again.

As shown in FIG. 3C, two input ports of the bridge 901 are respectively connected to an output port of the bridge 133 and an output port of the bridge 903. Two output ports of the bridge 901 are respectively connected to two radiating element arrays on the installation surface 123 and the installation surface 122. Two input ports of the bridge 902 are respectively connected to an output port of the bridge 904 and an output port of the bridge 905. Two output ports of the bridge 902 are respectively connected to two radiating element arrays on the installation surface 123 and the installation surface 122.

It can be learned from FIG. 3C that, when one side installation surface (the installation surface 123 or the installation surface 122) in the antenna apparatus is in a working state, while other installation surfaces are not in a working state, power of signals sent by radio frequency ports connected to radiating element arrays on the installation surface in a working state may be concentrated on the radiating element arrays on the installation surface, thereby reducing a power waste.

For example, when the installation surface 123 is in a working state, while the installation surface 122 and the installation surface 121 are not in a working state, power of signals sent by the radio frequency port r1 and the radio frequency port r2 may be concentrated on a signal sent by the output port s2, and then enter the bridge 133. Similarly, power of signals sent by the radio frequency port r3 and the radio frequency port r4 may be concentrated on a signal received by the input port p5 of the bridge 133. Further, because a signal received by the input port p6 and a signal received by the input port p5 may be controlled to meet a specific condition (for example, the bridge 133 is a 90-degree bridge, and the two signals have equal amplitudes and have a phase difference of 90 degrees), power of the signals received by the input port p6 and the input port p5 may be concentrated on a signal sent by the output port s5, and then enter the bridge 901. Therefore, power of signals sent by the radio frequency port r1, the radio frequency port r2, the radio frequency port r3, and the radio frequency port r4 may be concentrated on one input port of the bridge 901. Similarly, power of signals sent by four radio frequency ports (for example, four radio frequency ports connected to the bridge 903 shown in FIG. 3C) connected to another circuit unit may be concentrated on another input port of the bridge 901.

In addition, because signals received by the two input ports of the bridge 901 may be controlled to meet a specific condition (for example, the bridge 901 is a 90-degree bridge, and the two signals have equal amplitudes and have a phase difference of 90 degrees), power of the signals received by the two input ports of the bridge 901 may be concentrated on one output port of the bridge 901. Therefore, with the antenna apparatus shown in FIG. 3A, power of signals sent by the radio frequency port r1, the radio frequency port r2, the radio frequency port r3, the radio frequency port r4, and the four radio frequency ports connected to the bridge 903 may be concentrated on the radiating element array that is connected to the bridge 901 and that is located on the installation surface 123, thereby reducing a power waste.

Similarly, with the antenna apparatus shown in FIG. 3C, power of signals sent by the eight radio frequency ports connected to the bridge 902 may be concentrated on a radiating element array that is connected to the bridge 902 and that is located on the installation surface 123, thereby reducing a power waste.

A fourth bridge mentioned in this embodiment of this application may be the bridge 901 or the bridge 902 in FIG. 3C. As shown in FIG. 3C, the radiating element array is connected, by using the bridge 901 (fourth bridge), to eight radio frequency ports connected to two circuit units. In this way, the radiating element array 114 may obtain power of signals sent by all the radio frequency ports (the eight radio frequency ports) to which the radiating element array 114 is connected by using the fourth bridge, thereby reducing a power waste and improving power of a signal sent by the radiating element array 114.

FIG. 3C shows an example in which the fourth bridge is connected to all radio frequency ports connected to two circuit units. In actual application, the fourth bridge may alternatively be connected to all radio frequency ports connected to more circuit units. For example, one output port of the fourth bridge is connected to one radiating element array on the installation surface 123, and another output port of the fourth bridge may be connected to one radiating element array on the installation surface 122. Two input ports of the fourth bridge are respectively connected to an output port of a bridge 1 and an output port of a bridge 2. An input port of the bridge 1 is connected to all radio frequency ports connected to one circuit unit, and an input port of the bridge 2 is connected to all radio frequency ports connected to another circuit unit. In this way, the fourth bridge may be connected, by using the bridge 1 and the bridge 2, to 16 radio frequency ports connected to the two circuit units.

In this embodiment of this application, when an output port (for example, the output port s6 of the bridge 133, an output port of the bridge 903, an output port of the bridge 904, and an output port of the bridge 905 in FIG. 3C) of a bridge is not connected to a component such as an antenna, a bridge, or a power divider, to avoid a circuit burnout or the like, this embodiment of this application may provide a circuit protection measure, for example, connecting, to a load, the output port of the bridge that is not connected to a component such as an antenna, a bridge, or a power divider.

It should be noted that the access network devices shown in FIG. 3A, FIG. 3B, and FIG. 3C are improvements based on the architecture of the access network device shown in FIG. 2C (the antenna apparatus of the access network device shown in FIG. 2C includes three installation surfaces). Alternatively, the architectures shown in FIG. 3A, FIG. 3B, and FIG. 3C may be improvements based on the architecture of the access network device shown in FIG. 2A (the antenna apparatus of the access network device shown in FIG. 2A includes two installation surfaces). In this case, the solutions provided by the antenna apparatuses 1 shown in FIG. 3A, FIG. 3B, and FIG. 3C are also applicable. For example, the installation surface 123 and the radiating element arrays installed on the installation surface 123 are not disposed in the antenna apparatus 1 shown in FIG. 3A, FIG. 3B, or FIG. 3C. Other content is similar to the foregoing content, and details are not described again.

In this embodiment of this application, when the third bridge is the bridge 133, the fourth bridge may be the bridge 901, a seventh input port of the fourth bridge may be a port that is on the bridge 901 and that is connected to the output port s5 of the bridge 133, an eighth input port of the fourth bridge may be a port that is on the bridge 903 and that is connected to an output port of the bridge 903, a seventh output port of the fourth bridge may be an output port that is on the bridge 901 and that is connected to the radiating element array 113, and an eighth output port of the fourth bridge may be an output port that is on the bridge 901 and that is connected to the radiating element array 114.

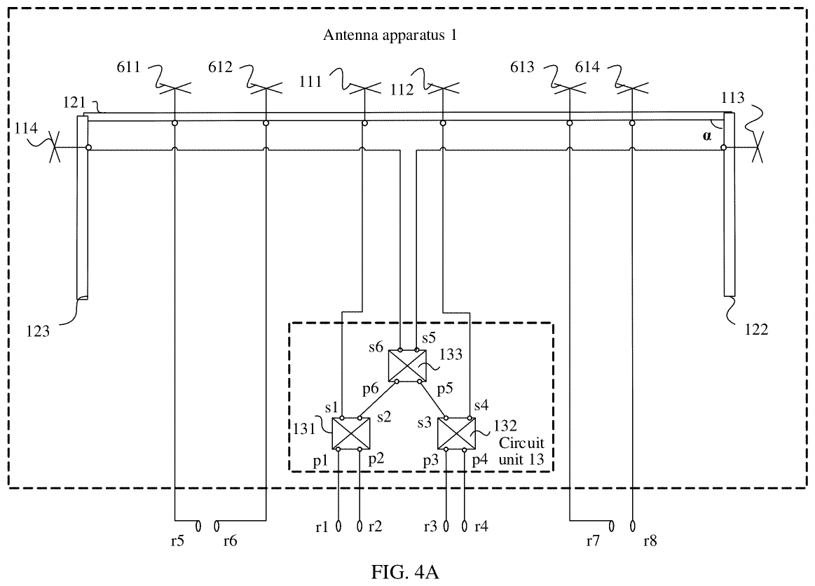

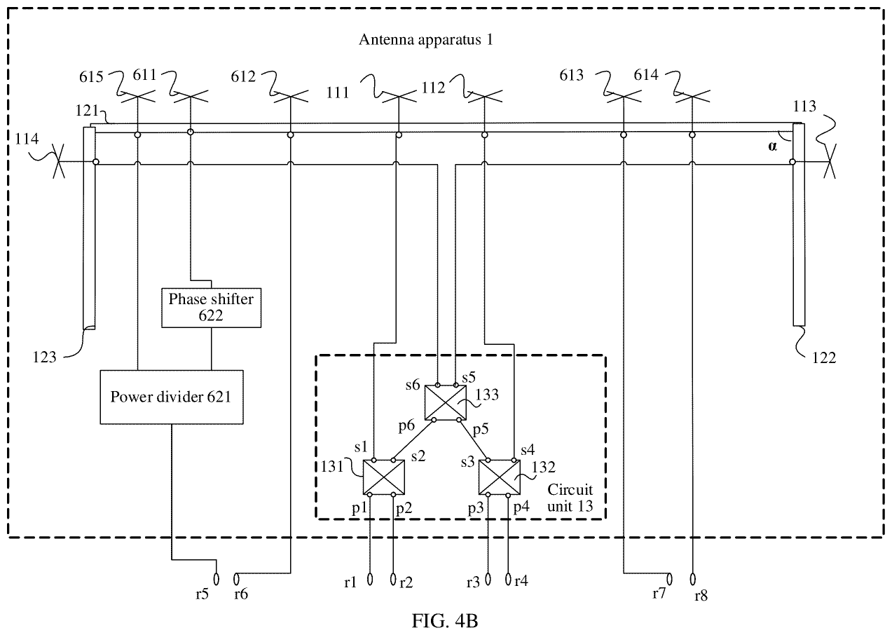

Based on the embodiments shown in FIG. 2A, FIG. 2B, FIG. 2C, FIG. 2D, FIG. 2E, FIG. 3A, FIG. 3B, and FIG. 3C, and other content, FIG. 4A and FIG. 4B show example diagrams of several possible architectures of the antenna apparatus 1 according to an embodiment of this application. As shown in FIG. 4A and FIG. 4B, the installation surface 121 further includes N5 radiating element arrays. N5 is 1 or an integer greater than 1. In this embodiment of this application, the N5 radiating element arrays are connected to one radio frequency port (for differentiation, the radio frequency port may be referred to as a fifth radio frequency port).

As shown in FIG. 4A, the N5 radiating element arrays may include a radiating element array 611 in FIG. 4A. The radiating element array 611 is connected to a radio frequency port r5, and power of a signal sent by the radio frequency port r5 is concentrated on the radiating element array 611. Similarly, a radiating element array 612 is connected to a radio frequency port r6, and power of a signal sent by the radio frequency port r6 is concentrated on the radiating element array 612. A radiating element array 613 is connected to a radio frequency port r7, and power of a signal sent by the radio frequency port r7 is concentrated on the radiating element array 613. A radiating element array 614 is connected to a radio frequency port r8, and power of a signal sent by the radio frequency port r8 is concentrated on the radiating element array 614.

As shown in FIG. 4B, the N5 radiating element arrays may include radiating element arrays 611 and 615 in FIG. 4B. Both the radiating element array 611 and the radiating element array 615 are connected to one radio frequency port r5. When one radio frequency port is connected to a plurality of radiating element arrays, the radio frequency port may be connected to the plurality of radiating element arrays by using a power divider. Further, at least one of the plurality of radiating element arrays is connected to the power divider by using a phase shifter. For example, the radio frequency port r5 may be connected to the radiating element array 611 and the radiating element array 615 by using a power divider 621. The radiating element array 611 is connected to the power divider 621 by using a phase shifter 622. Power of a signal sent by the radio frequency port r5 may be allocated to the radiating element array 611 and the radiating element array 615.

With the power divider, more radiating element arrays can be supported without increasing a quantity of radio frequency ports. Because the quantity of radio frequency ports is small, this solution can reduce costs. In addition, because a quantity of radiating element arrays can be increased, performance of the antenna apparatus can be improved. Because a phase of a signal to be sent by the radiating element array may be adjusted by using the phase shifter, a beamforming capability (which may also be referred to as a beam scanning capability) of the radiating element array connected to the phase shifter may be improved.

It can be learned from the antenna apparatuses shown in FIG. 4A and FIG. 4B that, when there are a large quantity of radiating element arrays on the installation surface 121, radio frequency ports may be disposed in one-to-one and/or one-to-many correspondence with antenna ports. In this way, a quantity of radio frequency links can be reduced. In addition, when the installation surface 121 is in a working state, while the installation surface 123 and the installation surface 122 are not in a working state, power of signals sent by the radio frequency port r5, the radio frequency port r6, the radio frequency port r7, the radio frequency port r8, the radio frequency port r1, the radio frequency port r2, the radio frequency port r3, and the radio frequency port r4 is concentrated on the radiating arrays on the installation surface 121, so that power of signals sent by the radiating arrays installed on the installation surface 121 can be increased.

It should be noted that the antenna apparatus 1 shown in FIG. 4A may alternatively include a plurality of circuit units 13. FIG. 4A shows an example in which the antenna apparatus 1 includes one circuit unit. In addition, for example, the circuit unit 13 in FIG. 4A is the circuit unit 13 shown in FIG. 2C. In actual application, the circuit unit 13 in FIG. 4A may alternatively be the circuit unit 13 shown in FIG. 2E. A third power divider in this embodiment of this application may be the power divider 621, and a third phase shifter may be the phase shifter 622.

In a possible implementation, when a quantity of radio frequency ports is equal to a total quantity of radiating element arrays, the bridge includes two input ports and two output ports. In the antenna apparatus, a quantity of bridges (the bridges may be referred to as first-level bridges) directly connected to radio frequency ports is denoted as H (H is a positive integer), a quantity of radiating element arrays directly connected to radio frequency ports is denoted as R (R is 0 or a positive integer), and a total quantity of radio frequency ports is denoted as N (N is a positive integer). In this case, in a possible implementation, N=R+2H. In another possible implementation, a quantity of radio frequency ports included on a front installation surface (for example, the installation surface 121) may be denoted as K (K is a positive integer). In this case, in a possible implementation, K=R+H. Alternatively, the formula may be written as mathematical constraint formulas: H=N−K and R=K−H. In a possible implementation, it is expected that the quantity R is 0. In this case, H=N/2, and then K=N/2 may be obtained. In other words, the quantity of first-level bridges is N/2, that is, half of the quantity of radio frequency ports.

A bridge that is in the antenna apparatus 1 and connected to a radio frequency port may be referred to as a first-level bridge, and a bridge connected to an output port of the first-level bridge may be referred to as a second-level bridge. A quantity of second-level bridges included in the circuit unit 13 of the antenna apparatus 1 may be half of the quantity of first-level bridges. Two output ports of the second-level bridge may be respectively connected to two radiating element arrays on two side installation surfaces (for example, the installation surface 123 and the installation surface 122). If an output port of a bridge at a level is not connected to a component such as an antenna, a bridge, or a power divider, to avoid a circuit burnout or the like, the output port of the bridge at the level that is not connected to a component such as an antenna, a bridge, or a power divider may be connected to a load.

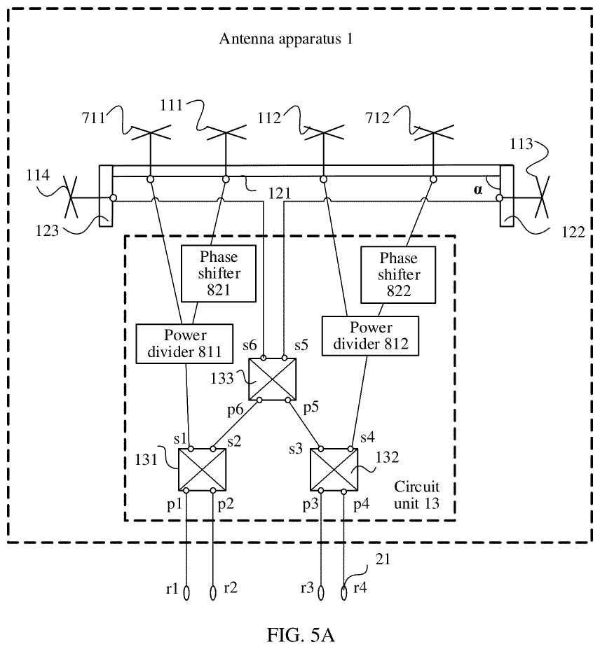

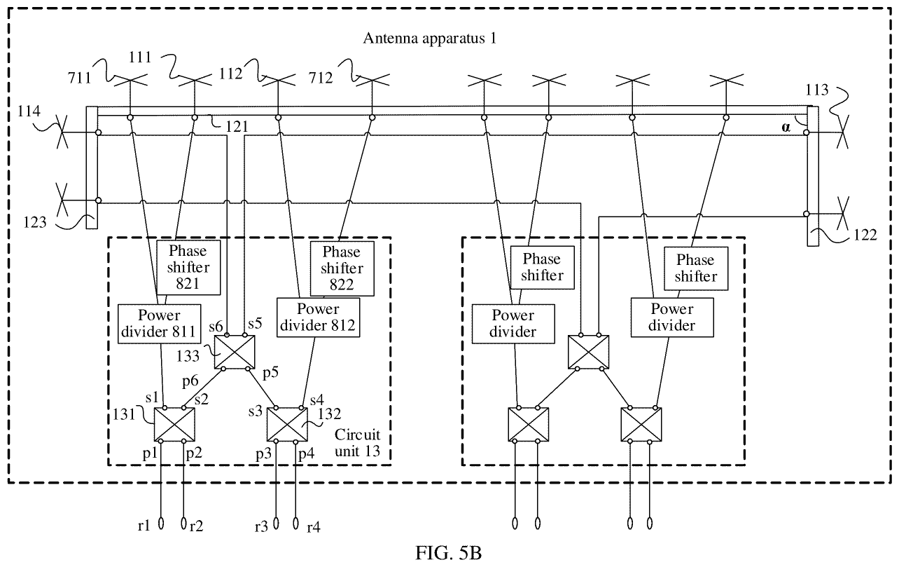

Based on the embodiments shown in FIG. 2A, FIG. 2B, FIG. 2C, FIG. 2D, FIG. 2E, FIG. 3A, FIG. 3B, FIG. 3C, FIG. 4A, and FIG. 4B, and other content, FIG. 5A and FIG. 5B show example diagrams of several other possible architectures of the antenna apparatus 1 according to an embodiment of this application.

FIG. 5A shows an example improvement based on the antenna apparatus 1 shown in FIG. 2C. A difference from FIG. 2C lies in that an output port s1 in FIG. 5A is connected to N1 radiating element arrays, where FIG. 5A shows an example in which N1 is 2, and the output port s1 is connected to a radiating element array 111 and a radiating element array 711. An output port s4 is connected to N2 radiating element arrays, where FIG. 5A shows an example in which N2 is 2, and the output port s4 is connected to a radiating element array 112 and a radiating element array 712.

As shown in FIG. 5A, the output port s1 may be split into N1 ports by using a power divider 811, and then the N1 ports of the power divider 811 may be connected to the N1 radiating element arrays in one-to-one correspondence.

Specifically, one of the N1 ports of the power divider 811 is connected to one of the N1 radiating element arrays, and one of the N1 radiating element arrays is connected to one of the N1 ports of the power divider 811.

With a function of the power divider 811, power of a signal sent by the output port s1 may be allocated to the N1 radiating element arrays connected to the power divider 811. With the power divider, more radiating element arrays can be supported without increasing a quantity of radio frequency ports. Because the quantity of radio frequency ports is small, this solution can reduce costs. In addition, because a quantity of radiating element arrays can be increased, performance of the antenna apparatus can be improved.

In another possible implementation, the antenna apparatus 1 may further include one or more phase shifters. For example, the antenna apparatus further includes a first phase shifter, and the first bridge is connected to a radiating element array in the N1 radiating element arrays by using the first phase shifter. A phase of a signal output by the first bridge may be changed by using the first phase shifter, so that adjustability of the antenna apparatus in an actual application scenario can be improved.

For another example, the antenna apparatus further includes a second phase shifter, and the second bridge is connected to a radiating element array in the N2 radiating element arrays by using the second phase shifter. A phase of a signal output by the second bridge may be changed by using the second phase shifter, so that adjustability of the antenna apparatus in an actual application scenario can be improved.

In this embodiment of this application, the power divider in the antenna apparatus may be used in combination with the phase shifter. For example, as shown in FIG. 5A, at least one of the N1 radiating element arrays is connected to the power divider 811 by using a phase shifter. For example, the radiating element array 111 in FIG. 5A is connected to the power divider 811 by using a phase shifter 821. Because a phase of a signal to be sent by the radiating element array may be adjusted by using the phase shifter, a beamforming capability (which may also be referred to as a beam scanning capability) of the N1 radiating element arrays may be improved.

Similarly, as shown in FIG. 5A, the output port s4 may be split into N2 ports by using the power divider 812, and then the N2 ports of the power divider 812 may be connected to the N2 radiating element arrays in one-to-one correspondence. Specifically, one of the N2 ports of the power divider 812 is connected to one of the N2 radiating element arrays, and one of the N2 radiating element arrays is connected to one of the N2 ports of the power divider 812. With a function of the power divider 812, power of a signal sent by the output port s4 may be allocated to the N2 radiating element arrays connected to the power divider 812. In another possible implementation, at least one of the N2 radiating element arrays is connected to the power divider 812 by using a phase shifter. For example, the radiating element array 712 in FIG. 5A is connected to the power divider 812 by using a phase shifter 822.

It should be noted that a first power divider mentioned in this embodiment of this application may be the power divider 811, a second power divider may be the power divider 812, a first phase shifter may be the phase shifter 821, and a second phase shifter may be the phase shifter 822.

Compared with FIG. 5A, FIG. 5B shows an example in which the antenna apparatus 1 includes two circuit units 13. For content of each circuit unit 13, refer to descriptions of FIG. 5A. Details are not described again.

It should be noted that the access network devices shown in FIG. 5A and FIG. 5B are improvements based on the architecture of the access network device shown in FIG. 2C (the antenna apparatus of the access network device shown in FIG. 2C includes three installation surfaces). Alternatively, the architectures shown in FIG. 5A and FIG. 5B may be improvements based on the architecture of the access network device shown in FIG. 2A (the antenna apparatus of the access network device shown in FIG. 2A includes two installation surfaces). In this case, the solutions provided by the antenna apparatuses 1 shown in FIG. 5A and FIG. 5B are also applicable. For example, the installation surface 123 and the radiating element array installed on the installation surface 123 may not be disposed in the antenna apparatus 1 shown in FIG. 5A or FIG. 5B. Other content is similar to the foregoing content, and details are not described again.

The antenna apparatus 1 provided in this embodiment of this application may include a plurality of circuit units, and each of the plurality of circuit units may be the circuit unit 13 shown in FIG. 5A. In addition, the solutions shown in FIG. 5A and FIG. 5B may alternatively be used in combination with the content shown in FIG. 2E, FIG. 3A, FIG. 3B, FIG. 4A, or FIG. 4B. For example, the antenna apparatus 1 may include a plurality of circuit units. A structure form of at least one of the plurality of circuit units may be a structure form of the circuit unit 13 shown in FIG. 5A, and a structure form of at least one of the plurality of circuit units may be a structure form of the circuit unit 13 shown in FIG. 2C. For another example, the antenna apparatus 1 may include one or more circuit units. One circuit unit in the antenna apparatus 1 is the circuit unit 13 shown in FIG. 5A or FIG. 2C. The antenna apparatus 1 may further include the N5 radiating element arrays shown in FIG. 4A or FIG. 4B. The N5 radiating element arrays may be connected to one radio frequency port.

In a possible implementation, when a quantity of radio frequency ports is less than a total quantity of radiating element arrays, a power divider may be introduced, and a quantity of bridges (the bridges may be referred to as first-level bridges) in the antenna apparatus and directly connected to radio frequency ports may be equal to half of the quantity of radio frequency ports.

An output port of a bridge that is in the antenna apparatus and directly connected to a radio frequency port may be connected to a power divider, or may be directly connected to an antenna port connected to a radiating element array. A quantity of output ports of the power divider may be not less than 2, at least one output port of the power divider may be connected to a phase shifter (which may also be referred to as an adjustable phase shifter), and an output port of the phase shifter may be directly connected to an antenna port connected to a radiating element array.

A bridge that is in the antenna apparatus 1 and directly connected to a radio frequency port may be referred to as a first-level bridge, and a bridge connected to an output port of the first-level bridge may be referred to as a second-level bridge. A quantity of second-level bridges included in the circuit unit 13 of the antenna apparatus 1 may be half of a quantity of first-level bridges. Two output ports of the second-level bridge may be respectively connected to two radiating element arrays on two side installation surfaces (for example, the installation surface 123 and the installation surface 122).

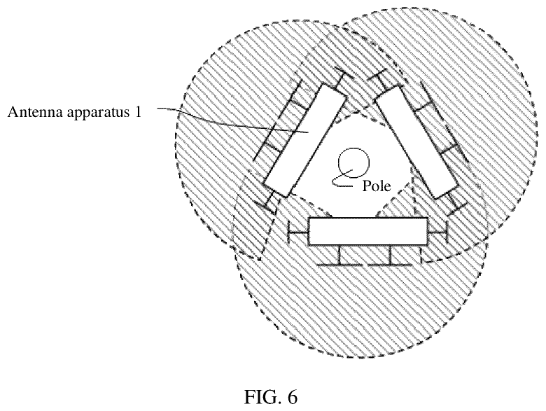

Based on the foregoing content, FIG. 6 is an example diagram of a structure of a communication system to which embodiments of this application are applicable. The communication system includes three antenna apparatuses disposed on a pole, and a structure of each antenna apparatus may be the foregoing antenna apparatus 1 (for a structural form of the antenna apparatus 1, refer to the embodiment shown in FIG. 2C, FIG. 2D, FIG. 2E, FIG. 3A, FIG. 3B, FIG. 4A, FIG. 5A, or FIG. 5B). As shown in FIG. 6, in each antenna apparatus, a radiating element array on one installation surface may be in a working state, while another installation surface is not in a working state (for example, a radiating element array on a front installation surface (the installation surface 121) of the antenna apparatus 1 is in a working state, while radiating element arrays on two side installation surfaces (the installation surface 122 and the installation surface 123) are not in a working state). In this case, the radiating element array on the installation surface in a working state in each antenna apparatus may be allocated power of a signal sent by a radio frequency port connected to the radiating element array, so that power utilization can be improved, and a power waste can be reduced.

In addition, when a plurality of antenna apparatuses are deployed, the plurality of antenna apparatuses may implement multi-sector collaboration. When a base station has a plurality of sectors, and some sectors have a large quantity of users, while some sectors have a small quantity of users or even no users, according to the solution provided in this embodiment of this application, power of a sector with a small quantity of users or even no users may be transmitted to a sector with a large quantity of users, to improve signal strength of the sector with a large quantity of users, so that a user-perceived rate and coverage performance can be improved.

The antenna apparatus provided in embodiments of this application can implement 360° full coverage of a radiated signal of one cell 3 by a single station with one antenna and one cell, thereby helping reduce costs of the communication system. The antenna apparatus provided in embodiments of this application can implement a single station with one antenna and three cells. For example, the antenna apparatus 1 includes three installation surfaces. A radiated signal of a radiating element array disposed on each installation surface covers one cell (for example, one cell is a 120° sector region). This solution helps reduce costs of the communication system.

In addition to the foregoing several networking forms, networking forms such as a single station with one antenna and one cell, a single station with one antenna and three cells, a single station with three antennas and six cells, and a single station with three antennas and nine cells can also be implemented. For example, each antenna apparatus 1 in the three antennas may cover three cells 3. In this case, the networking form of a single station with three antennas and nine cells may be implemented. This is not limited in this application.

It is clear that a person skilled in the art can make various modifications and variations to this application without departing from the protection scope of this application. Therefore, this application is intended to cover these modifications and variations of this application provided that they fall within the scope of the claims of this application and their equivalent technologies.

What is claimed is:

1. An antenna apparatus, comprising a first installation surface, a second installation surface, a plurality of radiating element arrays, and a first circuit, wherein the first circuit comprises a first bridge, a second bridge, and a third bridge, wherein:
a first input port of the first bridge is connected to a first radio frequency port, a second input port of the first bridge is connected to a second radio frequency port, a first output port of the first bridge is connected to antenna ports connected to N1 radiating element arrays that are in the plurality of radiating element arrays and that are disposed on the first installation surface, N1 is a positive integer, and a second output port of the first bridge is connected to a fifth input port of the third bridge;
a third input port of the second bridge is connected to a third radio frequency port, a fourth input port of the second bridge is connected to a fourth radio frequency port, a third output port of the second bridge is connected to antenna ports connected to N2 radiating element arrays that are in the plurality of radiating element arrays and that are disposed on the first installation surface, N2 is a positive integer, each of the N2 radiating element arrays is different from each of the N1 radiating element arrays, and a fourth output port of the second bridge is connected to a sixth input port of the third bridge; and
a fifth output port of the third bridge is connected to antenna ports connected to N3 radiating element arrays disposed on the second installation surface, N3 is a positive integer, an included angle between the first installation surface and the second installation surface on a side that is away from the N1 radiating element arrays is a first included angle, and the first included angle is less than 180°.

2. The antenna apparatus according to claim 1,
wherein the antenna apparatus further comprises a third installation surface; and
wherein a sixth output port of the third bridge is connected to antenna ports connected to N4 radiating element arrays disposed on the third installation surface, and N4 is a positive integer.

3. The antenna apparatus according to claim 1, wherein the antenna apparatus further comprises a fourth bridge, and the third bridge is connected to the N3 radiating element arrays by using the fourth bridge.

4. The antenna apparatus according to claim 3, wherein the antenna apparatus further comprises a second circuit, and an eighth input port of the fourth bridge is connected to a ninth output port of the second circuit.

5. The antenna apparatus according to claim 3, wherein the antenna apparatus further comprises a third installation surface; and
an eighth output port of the fourth bridge is connected to antenna ports connected to N4 radiating element arrays disposed on the third installation surface, and N4 is a positive integer.

6. The antenna apparatus according to claim 2, wherein the third installation surface and the second installation surface are located on two opposite sides of the first installation surface.

7. The antenna apparatus according to claim 1, wherein the antenna apparatus further comprises a first power divider, and the first bridge is connected to the N1 radiating element arrays by using the first power divider.

8. The antenna apparatus according to claim 1, wherein the antenna apparatus further comprises a first phase shifter, and the first bridge is connected to a radiating element array in the N1 radiating element arrays by using the first phase shifter.

9. The antenna apparatus according to claim 1, wherein the antenna apparatus further comprises a first microstrip, and the first bridge is connected to the N1 radiating element arrays by using the first microstrip.

10. The antenna apparatus according to claim 9, wherein the first microstrip is configured to delay, by a first preset value, a first phase of a first signal output by the first output port of the first bridge.

11. The antenna apparatus according to claim 10, wherein the first preset value is determined based on a phase difference between the first phase of the first signal output by the first output port of the first bridge and a second phase of a second signal received by the N3 radiating element arrays.

12. The antenna apparatus according to claim 1, wherein the antenna apparatus further comprises a second power divider, and the second bridge is connected to the N2 radiating element arrays by using the second power divider.

13. The antenna apparatus according to claim 1, wherein the antenna apparatus further comprises a second phase shifter, and the second bridge is connected to a radiating element array in the N2 radiating element arrays by using the second phase shifter.

14. The antenna apparatus according to claim 1, wherein the antenna apparatus further comprises a second microstrip, and the second bridge is connected to the N2 radiating element arrays by using the second microstrip.

15. The antenna apparatus according to claim 14, wherein the second microstrip is configured to delay, by a second preset angle, a third phase of a third signal output by the third output port of the second bridge.

16. The antenna apparatus according to claim 15, wherein the second preset angle is determined based on a phase difference between the third phase of the third signal output by the third output port of the second bridge and a second phase of a second signal received by the N3 radiating element arrays.

17. A communication device, comprising:
an antenna apparatus, wherein the antenna apparatus comprises a first installation surface, a second installation surface, a plurality of radiating element arrays, and a first circuit, wherein the first circuit comprises a first bridge, a second bridge, and a third bridge, wherein:
a first input port of the first bridge is connected to a first radio frequency port, a second input port of the first bridge is connected to a second radio frequency port, a first output port of the first bridge is connected to antenna ports connected to N1 radiating element arrays that are in the plurality of radiating element arrays and that are disposed on the first installation surface, N1 is a positive integer, and a second output port of the first bridge is connected to a fifth input port of the third bridge;
a third input port of the second bridge is connected to a third radio frequency port, a fourth input port of the second bridge is connected to a fourth radio frequency port, a third output port of the second bridge is connected to antenna ports connected to N2 radiating element arrays that are in the plurality of radiating element arrays and that are disposed on the first installation surface, N2 is a positive integer, each of the N2 radiating element arrays is different from each of the N1 radiating element arrays, and a fourth output port of the second bridge is connected to a sixth input port of the third bridge; and
a fifth output port of the third bridge is connected to antenna ports connected to N3 radiating element arrays disposed on the second installation surface, N3 is a positive integer, an included angle between the first installation surface and the second installation surface on a side that is away from the N1 radiating element arrays is a first included angle, and the first included angle is less than 180°.

18. The communication device according to claim 17,
wherein the antenna apparatus further comprises a third installation surface; and
wherein a sixth output port of the third bridge is connected to antenna ports connected to N4 radiating element arrays disposed on the third installation surface, and N4 is a positive integer.

19. The communication device according to claim 17, wherein the antenna apparatus further comprises a fourth bridge, and the third bridge is connected to the N3 radiating element arrays by using the fourth bridge.

20. The communication device according to claim 19, wherein the antenna apparatus further comprises a second circuit, and an eighth input port of the fourth bridge is connected to a ninth output port of the second circuit.
